(19) United States
(12) Patent Application Publication
(10) Pub. No.: US 2025/0045852 A1
(43) Pub. Date: Feb. 6, 2025

(54) SYSTEMS AND METHODS FOR LINKING RESOURCE CONSUMPTION TO COMPUTER-IMPLEMENTED FEATURES, FUNCTIONALITIES, AND/OR DIGITAL RIGHTS USING CRYPTO TOKEN-ENABLED ASSET MANAGEMENT

(71) Applicant: Lucid Dream Software, Inc., Hoffman Estates, IL (US)

(72) Inventors: David R. Lewis, Hoffman Estates, IL (US); Aleksei Gurev, Moscow (RU); Mark Edward F. Barba, Manila (PH)

(73) Assignee: Lucid Dream Software, Inc., Hoffman Estates, IL (US)

(21) Appl. No.: 18/229,171

(22) Filed: Aug. 1, 2023

(51) Int. Cl. G06Q 50/18; G06Q 30/018; H04L 9/32

(52) U.S. Cl. CPC G06Q 50/184; G06Q 30/0185; H04L 9/3213

(57) ABSTRACT

A novel system and method are disclosed for associating computer-implemented features, functionalities, and/or digital asset rights with the consumption of consumable items using blockchain-based crypto-tokens. A new model of access authorization and licensing is achieved by linking the expenditure of crypto token transactions to the calculated expenditure of consumable items using the special features and functions of technology-enabled computer-implemented processes and methods performing these expenditures and controlling the access authorization and licensing as a function of blockchain immutable Smart Contract transactions. In addition, linking these same expenditures with the expenditure of digital asset rights, such as artwork printing, extends the value participation model to include manufacturers of consumable items, software developers, and digital rights creators such as artists.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the field of tracking and managing the consumption of items by controlling software features through the use of crypto tokens and secure asset management and more specifically relates to systems and methods for linking resource consumption to software features and/or digital rights, using crypto token-enabled asset management.

### BACKGROUND

Existing methods for tracking consumable items, such as printer ink and print media, and managing digital rights for artwork printing, typically require separate specialized software features for high-quality printing and production.

The description provided in the background section should not be assumed to be prior art merely because it is mentioned in or associated with the background section. The background section may include information that describes one or more aspects of the subject technology.

### SUMMARY

An exemplary method for controlling access to data and computing systems associated with consumable items using crypto tokens includes: creating a unique immutable crypto token associated with a consumable item; linking the crypto token with one or more executable functions of a computing system, the one or more executable functions associated with the consumable item, for measurement of consumption of the consumable item; storing, loading, and verifying the linked crypto token within a unique digital wallet by the computing system; evaluating, by the computing system, whether the linked crypto token is present and valid to make a determination; responsive to determining that the linked crypto token is present and valid, authorizing execution of the specific function of the computing system; and expending the linked crypto token via measured consumable consumption by the computing system.

Authorizing execution of the specific function of the computing system may include authorizing distribution and printing rights for protected digital artwork. The exemplary method may further include: creating a unique immutable crypto token associated with digital artwork printing rights, the unique immutable crypto token used by a printer controller associated with the specific function of the computing system to ensure that prints are generated in accordance with the digital artwork printing rights represented by the unique immutable crypto token; linking expenditure of printing rights with expenditure of the unique immutable crypto token; generating a digital print package including a watermarked preview image, the unique immutable crypto token representing a quantity of authorized prints, and a valid digital wallet account; and distributing the digital print package through a standalone Smart Contract.

The exemplary method may further include: securely storing the protected digital artwork in a storage system accessible via a verification and authentication process; verifying authenticity of the specific executable function of the computing system, the specific executable function including printing; tracking a quantity of prints generated based on the crypto token associated with the digital artwork printing rights; disallowing further prints to be generated after the quantity of prints generated equals and/or exceeds the quantity of authorized prints; and verifying the authenticity of the prints generated by checking the value of the crypto token associated with the digital artwork printing rights.

The exemplary method may further include: monitoring the consumption of consumable items during a printing process; comparing the monitored consumption with an authorized amount of consumption based on the crypto token associated with the digital artwork printing rights; and disallowing further prints to be generated after the monitored consumption equals and/or exceeds the authorized amount of consumption based on the crypto token associated with the digital artwork printing rights.

The digital artwork printing rights represented by the unique immutable crypto token limit printing rights to be exercised only within a predetermined period of time before the digital artwork printing rights represented by the unique immutable crypto token expire and the digital artwork printing rights become invalid.

The exemplary method may further include: receiving the consumable item to be recycled; verifying authenticity of the consumable item to be recycled based on a unique digital wallet containing a crypto token associated with the consumable item to be recycled; and updating a spent amount of the authorized consumable item expenditures in the associated crypto token within the digital wallet associated with the consumable item to be recycled, the spent amount being updated to an amount permitting further expenditures of the consumable item.

Updating the spent amount of the authorized consumable item expenditures in the associated crypto token within the digital wallet associated with the consumable item to be recycled may include: evaluating whether the digital wallet of the consumable item being recycled is holding valid existing digital rights to make a determination; responsive to determining that the digital wallet of the consumable item being recycled is holding valid existing digital rights, assigning a new digital wallet to the consumable item being recycled; and responsive to determining that the digital wallet of the consumable item being recycled is not holding valid existing digital rights, clearing or removing previous micro-transaction details from the digital wallet of the consumable item, and updating the spent crypto token within the digital wallet of the consumable item being recycled with a fresh crypto token for the consumable item.

An exemplary method for connecting physical consumable product consumption to features and functions of “System Verified” digital software utilizes digital wallets containing crypto tokens and blockchain Smart Contract technology. The “System Verified” digital software may perform an authenticity verification of the physical consumable product and/or the crypto tokens.

An exemplary system for connecting physical consumable product consumption to features and functions of “System Verified” digital software employs consumable-specific crypto tokens which are assigned to a unique digital wallet ID and encoded into a simple identifier, for example, a phrase, ID value, or QR code, and then associated with each unit item of consumable product. This may create a secure and reliable link between the physical item and its consumption via corresponding digital software features and rights, which may then be used to facilitate and control a wide variety of transactions in a trustless fashion.

An exemplary system and method for recycling a consumable item verifies authenticity of the consumable item to be recycled based on a unique digital wallet containing a crypto token associated with the consumable item. The exemplary system and method for recycling the consumable item may include a closed-loop recycling system that updates the spent amount of the authorized consumable item expenditures in the associated crypto token within the digital wallet to an amount permitting further expenditures of the consumable item. Updating the spent amount may include replacing the crypto token associated with the consumable item being recycled with a new crypto token designating a lower or zero spent amount of the authorized expenditures of the consumable item. The exemplary system and method for recycling the consumable item may include verifying the authenticity of the consumable item to ensure that the consumable item to be recycled is not a counterfeit. The exemplary system and method for recycling the consumable item may evaluate whether the digital wallet of the consumable item being recycled is holding valid existing digital rights, and responsive to determining that the digital wallet of the consumable item being recycled is holding valid existing digital rights, the exemplary system and method for recycling the consumable item may assign a new digital wallet to the consumable item being recycled. Responsive to determining that the digital wallet of the consumable item being recycled is not holding valid existing digital rights, the exemplary system and method for recycling the consumable item may clear or remove previous micro-transaction details, for example, to prevent any potential interference with the reuse of the same digital wallet after being recycled. In a closed-loop recycling process, the spent crypto token within the digital wallet may be updated with a fresh crypto token for the consumable item.

The exemplary systems and methods may provide valuable insights into consumer behavior and patterns by monitoring immutable transaction details, including popularity of specific consumable items, demand in various geographic regions, and the effectiveness of different distribution channels.

The exemplary systems and methods may facilitate optimization of production and distribution strategies, streamline supply chain efficiency, and facilitate development of new products that better meet the needs of consumers.

The exemplary systems and methods may provide and analyze real-time information regarding the consumption of the consumable items in different geographic regions to identify regions where expected usage is lower, indicating potential issues with counterfeit products, and facilitating the undertaking of measures to combat these issues.

The exemplary systems and methods may provide real-time tracking of inventory levels, facilitating rapid identification and addressing of any shortages or overstocking issues.

The exemplary systems and methods may provide real-time access to micro-transaction details, facilitating manufacturers and their distribution partners in monitoring and understanding global consumption of their products.

The exemplary systems and methods may provide a reliable source of information for manufacturers to make informed business decisions based on the accuracy and tamper-proof nature of the blockchain and/or micro-transaction management system.

An exemplary non-transitory computer-readable medium stores computer-readable instructions executable by a hardware computing processor to perform operations of a method for controlling access to data and computing systems associated with consumable items using crypto tokens as described herein.

An exemplary system for controlling access to data and computing systems associated with consumable items using crypto tokens includes at least one device including a hardware computing processor, the system being configured to perform operations of a method as described herein. The system may include a non-transitory memory having stored thereon computing instructions, executable by the hardware computing processor, to perform operations of a method for controlling access to data and computing systems associated with consumable items using crypto tokens as described herein.

An exemplary system for controlling access to data and computing systems associated with consumable items using crypto tokens includes at least one device including a hardware circuit operable to perform a function, the system being configured to perform operations of a method for controlling access to data and computing systems associated with consumable items using crypto tokens as described herein.

### BRIEF DESCRIPTION OF THE DRAWINGS

The accompanying drawings, which are incorporated in and constitute a part of this disclosure, illustrate various examples of the present disclosure. The elements in the figures are not necessarily to scale, emphasis instead being placed upon illustrating the principles of the disclosure. Moreover, in the figures, like-referenced numerals may designate to corresponding parts throughout the different views. Furthermore, the drawings may contain text or captions that may explain certain examples of the present disclosure. This text is included for illustrative, non-limiting, explanatory purposes of certain examples detailed in the present disclosure.

FIG. 1 is a schematic diagram illustrating an exemplary blockchain for a distributed ledger system that securely maintains linked records using cryptographic techniques.

FIG. 2 is a schematic diagram illustrating an exemplary blockchain system utilizing consensus algorithms (e.g., Proof of Work and/or Proof of Stake) alongside smart contracts, facilitating decentralized and reliable transactions at scale.

FIG. 3 is a schematic diagram illustrating exemplary creation, transfer, and validation of digital assets, including fungible tokens like cryptocurrencies and unique NFTs, on blockchain platforms through transactions and smart contracts.

FIG. 4 is a schematic diagram illustrating an exemplary system for authorizing software applications used with physical goods by measuring consumption, recording as transactions, and comparing the sum of transactions to the total sum of consumable goods recorded in the form of an immutable crypto token on the blockchain.

FIG. 5 is a schematic diagram illustrating an exemplary method for certifying software, generating a digital signature and NFT stored on a blockchain, and linking the software development licensing and distribution to the distribution and sale of consumable items.

FIG. 6 is a schematic diagram depicting an exemplary method of linking and limiting of the reproduction of art to “system verified” software applications by the consumable transactions, and then comparing the sum of those transactions to the total sum for the reproduction rights, as recorded in the form of an immutable crypto token stored on the blockchain.

FIG. 7 is a schematic diagram depicting an exemplary certification process of stakeholders including developers of software applications, manufacturers or distributors of consumable goods, intellectual property owners such as artists, and end-users who consume the certified products.

FIG. 8 is a schematic diagram depicting an exemplary method of authorizing specific features within software applications usable with physical goods by measuring the consumption of the goods using software-based calculations, recording transactions to a blockchain, and comparing the sum of these transactions to the total sum for the consumable goods recorded on an immutable crypto token on the blockchain.

FIG. 9 is a schematic diagram showing an exemplary “SmartSupplySystem (SSS)” integrated by developers of software applications usable with consumable goods.

FIG. 10 is a schematic diagram illustrating an exemplary method for distribution of digital reproduction rights of intellectual property by linking and limiting the actual reproduction act as recorded by system-verified software applications to the consumable transactions, such as printed sheets of media.

FIG. 11A is a schematic diagram illustrating an exemplary method for software certification through the issuance of a valid NFT and digital signature.

FIG. 11B is a schematic diagram illustrating an exemplary method for manufacturers or distributors submitting consumable goods for certification through the issuance of a valid crypto token.

FIG. 11C is a schematic diagram illustrating an exemplary method for intellectual property owners submitting digital IP for certification through the issuance of a valid NFT digital token.

FIG. 11D is a schematic diagram illustrating an exemplary method for end-users purchasing consumable goods, procuring NFT-signed software, using a method of loading tokens to enable features as disclosed herein, and optionally purchasing digital reproductive rights to NFT-enabled IP.

FIG. 12 is a schematic diagram showing an exemplary high-level system architecture diagram illustrating the various components of the system, including software applications, consumable goods, and digital intellectual property rights, managed through blockchain technology.

FIG. 13 is a schematic diagram highlighting exemplary processes and interactions between different stakeholders, for example, developers, manufacturers, intellectual property owners, and end users, facilitated by the transparent, secure, and automated nature of the system.

FIG. 14 is a schematic diagram depicting an exemplary SmartSupplySystem Software Development Kit (SSS-SDK) integrated with an embedded printer controller software.

FIG. 15 is a schematic diagram illustrating an exemplary SSS technology establishing a secure connection with the Enhanced SSS Server, verifying the system OS-verified digital signature of the software, loading the digital wallet and data accounts, and checking for the presence of digital wallets containing valid crypto tokens for consumable products, with actions presented to the user through a web-enabled window or dialogue.

FIG. 16 is a schematic diagram illustrating an exemplary user's printing application as it sends fully rendered rasterized files of a print job, along with print control files, to an embedded printer controller software.

FIG. 17 is a schematic diagram illustrating an exemplary process on how an SSS-enabled printer controller software may calculate a consumable print job transaction by combining the details for each consumable item used, connect to the designated blockchain, and compare the new transaction details with the consumable unit item allowed grand total value to determine whether the print job may be completed or not.

FIG. 18 is a schematic diagram illustrating an exemplary method in which the SSS-enabled technology calculates the print job transaction value and attempts to transfer the fractional value from the local user digital wallet to an on-chain ‘vault’ account using a Smart Contract, thereby reducing the local token supply.

FIG. 19A is a schematic diagram depicting an exemplary method in which a manufacturer or distributor of consumable goods submits details for specific types of consumable goods to the designated certification authority within the SSS system.

FIG. 19B is a schematic diagram depicting an exemplary method in which a contract agreement is reached among all involved parties, utilizing standard business practices.

FIG. 20 is a schematic diagram illustrating an exemplary method for a manufacturer or distributor creating unique labels for consumable items.

FIG. 21 is a schematic diagram showing an exemplary method for the creation of unique digital wallets and the transfer of cryptocurrency to a smart contract from these digital wallets to mint or transfer tokens and accounts according to the smart contract terms.

FIG. 22 is a schematic diagram illustrating an exemplary process to register SSS-verified consumables with the SSS-enabled software.

FIGS. 23A and 23B are illustrations showing how exemplary SSS technology may provide users with a more comprehensive and tailored experience by enhancing the functionality of professional software, such as a RIP, by triggering the authorization of numerous new features with the addition of SSS-enabled consumables.

FIG. 24 is a schematic diagram illustrating an exemplary Immutable Distributed Transaction Storage System (IDTSS) during an initial phase of consumable or digital IP token configuration, storage of details on the blockchain, and structure of the IDTSS, including a distributed peer-to-peer network storage system connected to an immutable database system.

FIG. 25 is a schematic diagram illustrating an exemplary method for manufacturers or distribution parties to access the IDTSS to gain business intelligence.

FIG. 26 is an illustration showing an exemplary SSS-SDK-enabled software used to monitor consumable levels and trigger events, for example, prompting the user to buy more consumables.

FIG. 27 is an illustration showing an exemplary method of triggering special offer events for users based on various conditions.

FIG. 28 is a flowchart illustrating exemplary groups or categories of digital IP as Crypto Tokenized Print Packages, which may exist as Smart Contracts on the blockchain.

FIG. 29 is a schematic diagram showing an exemplary method for installing the Crypto Tokenized Print Packages either directly using existing digital wallets or through the ‘Master’ Smart Contract during an initial digital wallet creation phase, linking the purchaser of the consumable to the Print Package token and providing a distribution reference for each token.

FIG. 30 is an illustration showing an exemplary method for securely enabling print rights orders.

FIG. 31 is an illustration showing an exemplary system and method for securely purchasing and printing limited rights digital artwork using blockchain technology and SSS-enabled software.

FIG. 32 is a schematic diagram showing an exemplary successful completion of an online order for digital artwork using the SSS-enabled software, in which a transaction is sent to a blockchain Smart Contract containing information about the artwork token and the number of authorized prints.

FIG. 33 is a schematic diagram illustrating an exemplary SSS-enabled software establishing a secure connection with a SSS-enhanced centralized server with the relevant information and tokens corresponding to the artwork as well as the authorized number of prints from the blockchain transaction.

FIG. 34 is a schematic diagram depicting an exemplary SSS-Enhanced server establishing a secure connection to the Verified SSS-enabled software through SSL/TLS protocols.

FIG. 35 is a schematic diagram illustrating an exemplary verified consumption of consumables to limit the total number of prints.

FIG. 36 is a schematic diagram illustrating an exemplary distributed quantity of shares for reconstruction of the original artwork, thereby protecting against unauthorized access and data loss or corruption.

FIG. 37 is an illustration representing exemplary value-added features of the SmartSupplySystem.

FIG. 38 is a flowchart depicting an exemplary method for a Smart Contract verifying inputs including the presence of SSS-enabled software and consumable tokens, as well as the availability of sufficient consumables to cover the print rights being granted.

FIG. 39 is a flowchart depicting an exemplary method for securely managing the transfer of an original artwork non-fungible token, a corresponding original image location, and a fungible print rights token to a digital wallet using a smart contract on a blockchain platform.

FIG. 40 is an illustration showing an exemplary additional capability of facilitating artists to set an expiration date for the crypto tokens.

FIG. 41 is a schematic diagram illustrating an exemplary decentralized system that integrates the tracking and managing of consumable items, controlling software features, and managing digital rights through the use of DAOs, blockchain-based crypto tokens, digital wallets, and Smart Contracts.

FIG. 42 is a flowchart illustrating an exemplary system for implementing a secure and efficient recycling program for consumable products.

FIG. 43 is an illustration depicting exemplary collection of real-time data on the geographical consumption of products.

FIG. 44 is a schematic diagram illustrating an exemplary comprehensive solution for manufacturers and their distribution partners to monitor and understand the global consumption of their products through real-time access to the micro-transaction details.

FIG. 45 is a flowchart illustrating an exemplary seamless integration with third-party services, such as e-commerce platforms, DRM systems, cloud-based storage providers, specialty consumable manufacturers, specialty software feature integrators, and more.

FIG. 46 is a flowchart conceptually illustrating exemplary customizable Smart Contracts and design options to include adjustable parameters for controlling the use, distribution, and recycling of artwork and consumable products.

FIG. 47 is a flowchart illustrating exemplary enhanced security measures that may be incorporated into the systems and methods described herein.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### Overview

Existing methods for tracking consumable items, such as printer ink and print media, and managing digital rights for artwork printing, are encumbered with various limitations and inefficiencies. Limitations may include the inability to link digital rights to actual print count, the difficulty in verifying the use of brand-name vs. counterfeit products, the inability to accurately predict usage levels, and/or the inability to control digital rights exposes artists to the risk of copyright infringement. Inefficiencies may result in higher risks for artists, lower volumes and higher support costs for manufacturers, and/or difficulty in estimating consumer and distributor inventory needs. The systems and methods described herein address the need for a more effective solution to address these issues and improve the overall efficiency of the market.

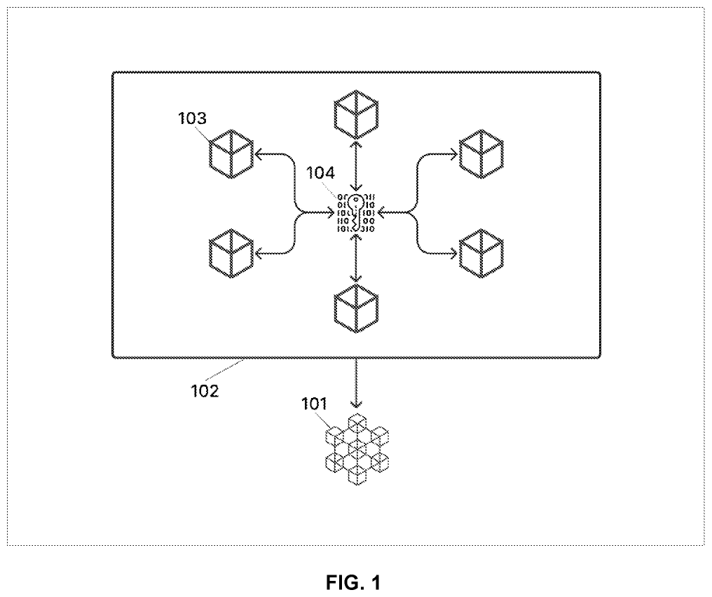

FIG. 1 is a schematic diagram illustrating an exemplary blockchain 101 for a distributed ledger system that securely maintains linked records using cryptographic techniques. The distributed ledger system may include a physical computer setup with high-performance processors, storage, and networking capabilities, facilitating efficient transaction processing by network nodes in a decentralized architecture, ensuring immutability and trustlessness while reducing reliance on central authorities. The blockchain 101, at its core, may include a distributed ledger 102 that maintains an ever-growing list of records, called blocks 103, that are linked and secured using cryptographic techniques 104. A first step in building a blockchain may involve setting up the physical computer requirements, which may include high-performance processors, ample storage, and robust networking capabilities. These components may facilitate nodes (e.g., the individual computers that participate in the network) to process and validate transactions quickly and efficiently. A blockchain typically utilizes a decentralized architecture wherein nodes maintain a copy of the ledger and work together to reach consensus on the state of the blockchain. Blockchain transactions, characterized by their immutability, are the foundation of trustlessness in the system. Once a transaction is recorded, it may not be altered or removed, and this immutability characteristic fosters transparency and reduces the call for participation of central authorities.

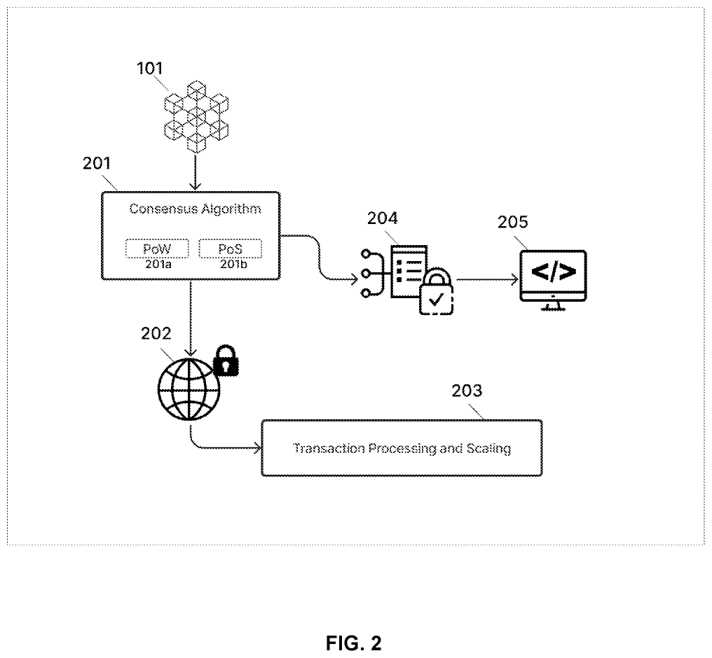

FIG. 2 is a schematic diagram illustrating an exemplary blockchain system utilizing consensus algorithms (e.g., Proof of Work and/or Proof of Stake), alongside smart contracts, facilitating decentralized and reliable transactions at scale. To ensure reliability, blockchain 101 networks may employ consensus algorithms 201, for example, Proof of Work (PoW) 201a or Proof of Stake (POS) 201b. These mechanisms may facilitate nodes reaching agreement on the state of the blockchain 101, while mitigating the risk of malicious actors taking control of the network 202. For example, the Solana network uses the POS-based Solana Cluster, which optimizes transaction processing and scales 203 to handle thousands of transactions per second. Smart contracts 204, e.g., self-executing programs that run on the blockchain 101, may be an integral component of networks such as these. Smart contracts 204 may facilitate the execution of complex, automated transactions and may be written in various programming languages 205, for example, C++ or Rust. The blockchain 101, in this context, may function as a decentralized networked virtual computer, executing smart contracts 204 while maintaining the properties of a physical computer, such as data storage and processing power.

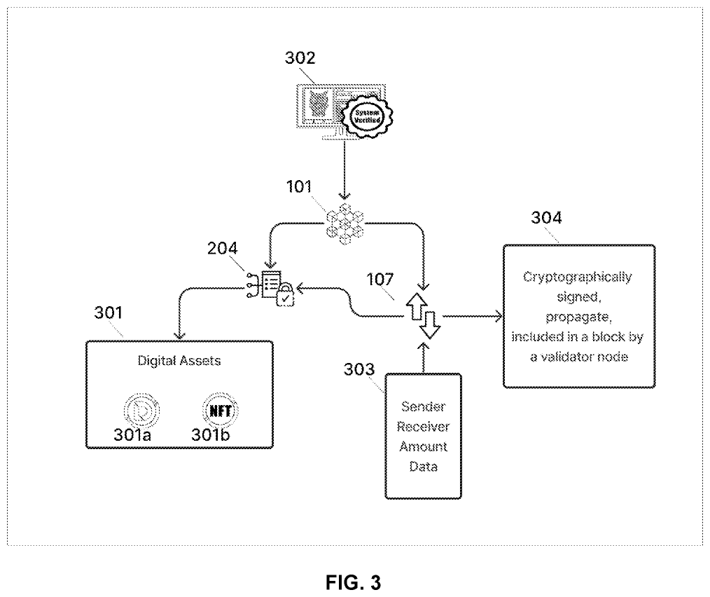

FIG. 3 is a schematic diagram illustrating exemplary creation, transfer, and validation of digital assets, including fungible tokens like cryptocurrencies and unique NFTs, on blockchain platforms through transactions and smart contracts. Fungible and non-fungible tokens (NFTs) are digital assets 301 that may be created, transferred, and burned on blockchain platforms. Fungible tokens, like cryptocurrencies 301a, are interchangeable and have a value that is consistent among all tokens of the same type. In contrast, NFTs 301b are unique digital assets that may represent ownership of a specific item or piece of content, such as artwork or a specific physical item. When computer systems 302 interact with the blockchain 101, they may submit transactions 107 to smart contracts 204 or initiate token transfers. A transaction typically contains information about the sender, receiver, amount, and any associated smart contract execution data 303. A validator node 304 may validate a transaction, wherein the transaction may be cryptographically signed, propagated through the network, and included in a block by the validator node 304. Upon consensus, the transaction may be considered final and become an immutable part of the blockchain 101.

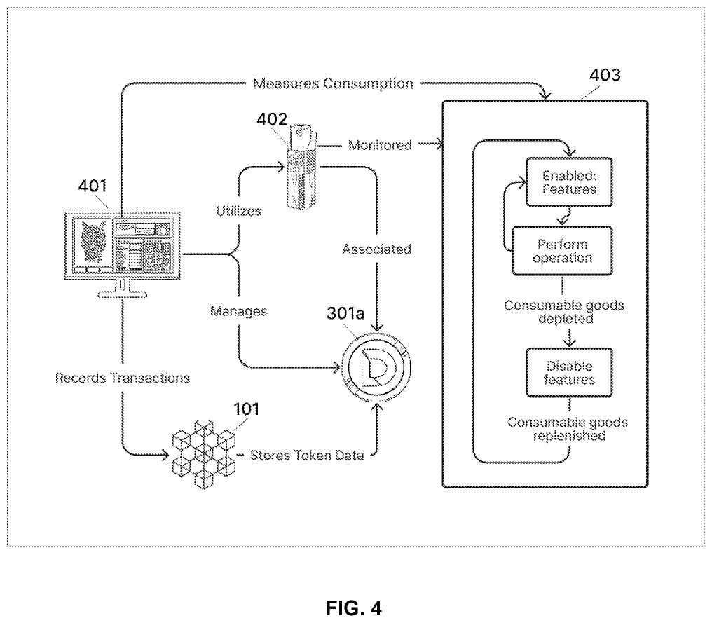

FIG. 4 is a schematic diagram illustrating an exemplary system for authorizing software applications 401 used with physical goods by measuring consumption, recording as transactions, and comparing the sum of transactions to the total sum of consumable goods recorded in the form of an immutable crypto token on the blockchain. Special, important, and/or critical features and functions within software applications 401, that may utilize and/or be commonly used in conjunction with the consumption of physical goods 402, may be authorized through a process of analyzing those features and functions to measure the consumption 403 of the physical goods 402 and record those measurements as transactions to an immutable decentralized data storage network, such as a blockchain 101. Enabling or disabling features may be performed by comparing the sum of those transactions to the total sum for the consumable goods, as recorded in the form of an immutable crypto token 301a stored on the blockchain 101.

The software applications 401 may manage the immutable crypto token 301a with which the physical goods 402 are associated. The process of measuring the consumption 403 of the physical goods 402 may include monitoring the physical goods 402. For example, via the immutable crypto token 301a, features of the software applications 401 may be enabled and operations associated with the enabled features may be performed until the consumable physical goods 402 are depleted. Upon the consumable physical goods 402 being depleted, the previously enabled features of the software applications 401 may be disabled until the consumable physical goods 402 are replenished. Upon their replenishment, the features of the software applications 401 may be enabled again and the cycle associated with the consumption 403 of the physical goods 402 may continue.

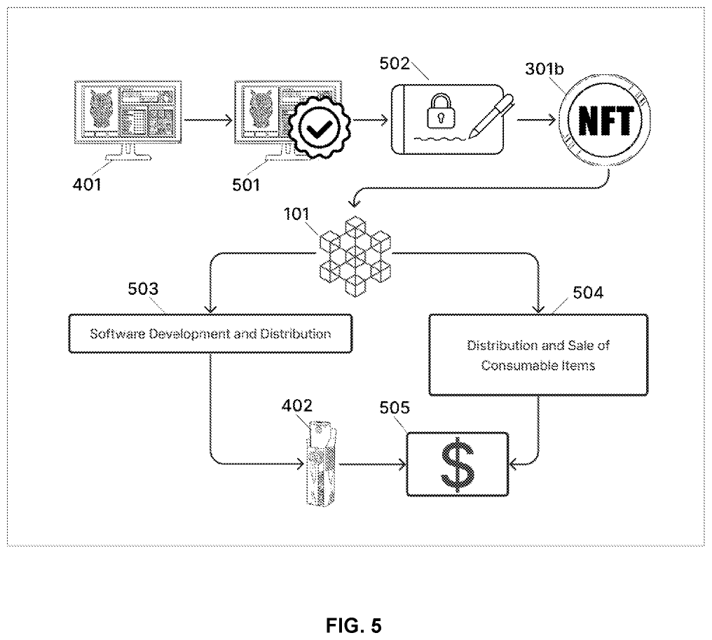

FIG. 5 is a schematic diagram illustrating an exemplary method for certifying software applications 401, generating a digital signature 502 and NFT 301b stored on a blockchain 101, and linking software development licensing and distribution 503 to the distribution and sale of consumable items 504. Software applications 401 that may be commonly used in conjunction with various consumable goods may be certified to become “system verified” software 501 and generate a digital signature 502 and NFT 301b, which may be stored on a blockchain 101. This system may incentivize software development and distribution by linking the software development licensing and distribution 503 to the distribution and sale of consumable items 504. This may create a seamless and automated ongoing revenue stream 505 associated with the consumable goods 402.

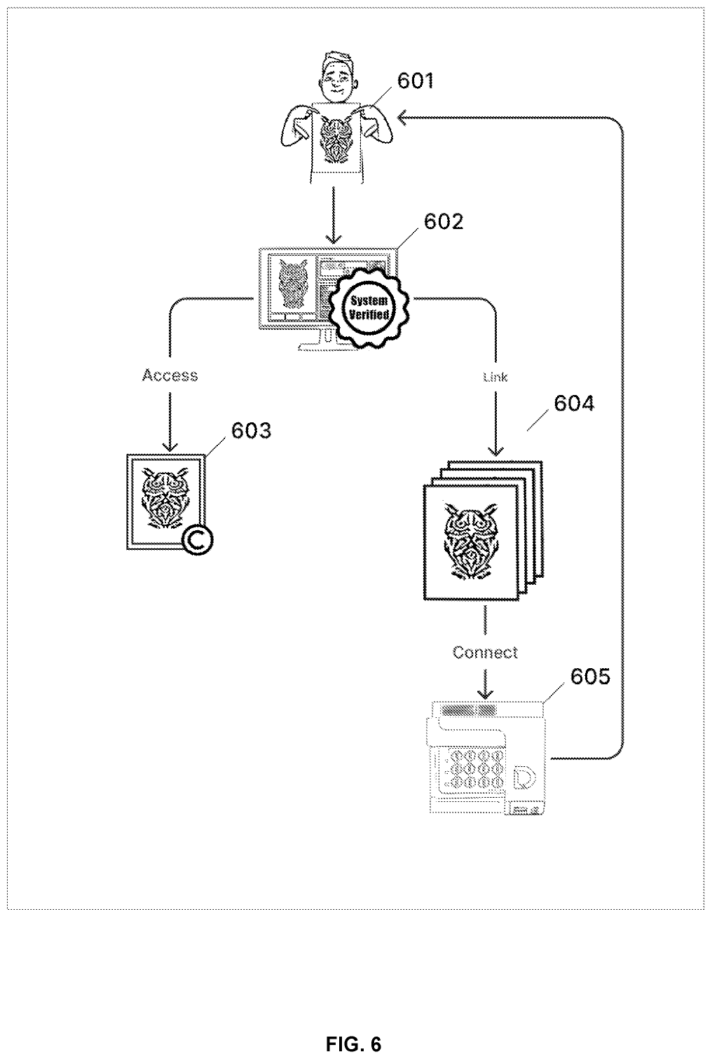

FIG. 6 is a schematic diagram depicting an exemplary method of linking and limiting of the reproduction of art to “system verified” software applications 602 by the consumable transactions, and then comparing the sum of those transactions to the total sum for the reproduction rights, as recorded in the form of an immutable crypto token stored on the blockchain. Distribution of digital reproduction rights 601 of intellectual property 603, such as copyrighted art, may be facilitated by linking and limiting the actual reproduction act 604 (e.g., printing copies) as recorded by the “system verified” software applications 602, to the consumable transactions 605, and then comparing the sum of those transactions to the total sum for the reproduction rights, as recorded in the form of an immutable crypto token stored on the blockchain.

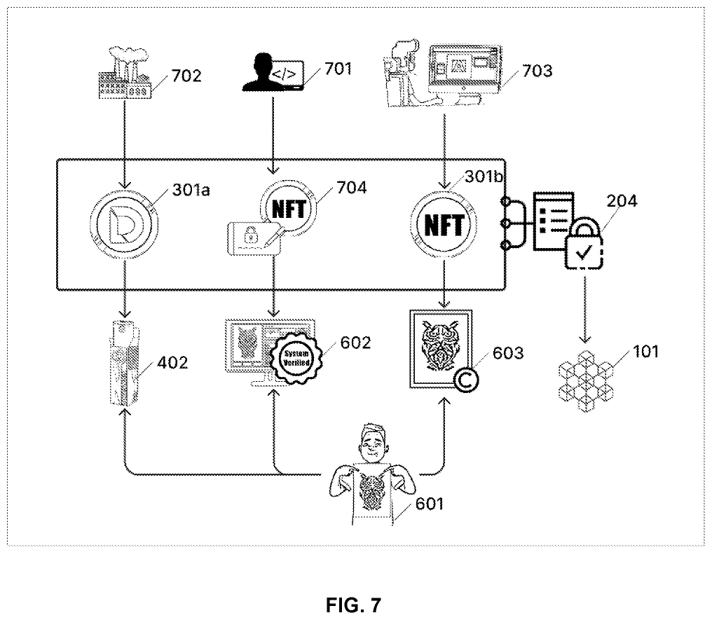

FIG. 7 is a schematic diagram depicting an exemplary certification process of stakeholders including developers of software applications, manufacturers or distributors of consumable goods, intellectual property owners such as artists, and end-users who consume the certified products. A smart contract 204 may securely link these stakeholders and their interactions to ensure certification and a seamless transaction process. The certification process may facilitate developers of software applications 701 to implement the technology described herein and submit the final software product for certification through the issuance of a valid NFT and digital signature 704. The certification process may also facilitate the manufacturers or distributors 702 of consumable goods to submit each consumable-good type and quantity measure for certification through the issuance of a valid crypto token 301a. The certification process may also facilitate intellectual property owners 703, such as artists, to submit digital intellectual property (IP) for certification through the issuance of a valid NFT digital token 301b. The certification process may also facilitate end users, e.g., clients who consume any or all of the above, to purchase the consumable goods 402, to procure the NFT-signed software 602 for use with the consumable goods 402, to use the herein disclosed method of loading the crypto tokens 301a to enable the features, and/or to optionally purchase digital reproductive rights 603 to NFT-enabled IP, all linked securely by a smart contract 204.

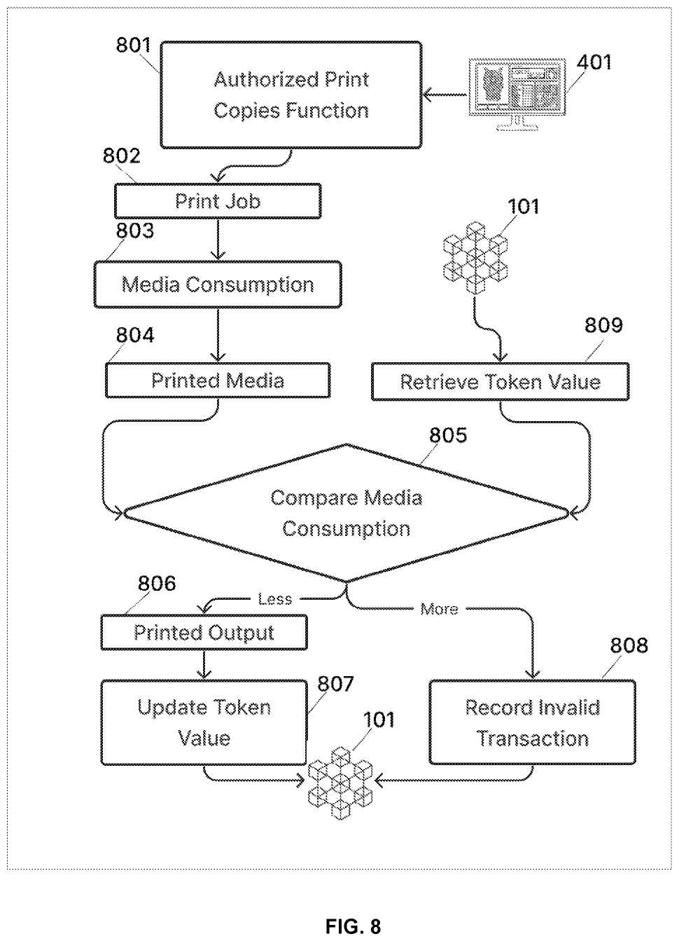

FIG. 8 is a schematic diagram depicting an exemplary method of authorizing specific features (e.g., a print copies function 801) within software applications (e.g., software applications 401) usable with physical goods (e.g., printed output 806) by measuring the consumption of the goods (e.g., media consumption 803, printed media 804) using software-based calculations (e.g., comparing media consumption 805), recording transactions (e.g., updating token value 807 and/or recording invalid transactions 808) to a blockchain 101, and comparing the sum of these transactions to the total sum (e.g., determined by retrieving the token value 809) for the consumable goods (e.g., printed output 806) recorded on an immutable crypto token (e.g., as a token value 809) on the blockchain 101. Exemplary systems and methods described herein may authorize specific, special, important, and/or critical features and functions (e.g., authorized print copies function 801) within software applications (e.g., software applications 401) that may be used in conjunction with the consumption of physical goods (e.g., printed output 806). The exemplary systems may facilitate and/or the exemplary methods may include: measuring the consumption of the physical goods using software-based calculations, recording these measurements as transactions to an immutable decentralized data storage network, such as a blockchain 101, and comparing the sum of these transactions to the total sum for the consumable goods, as recorded in the form of an immutable crypto token stored on the blockchain 101.

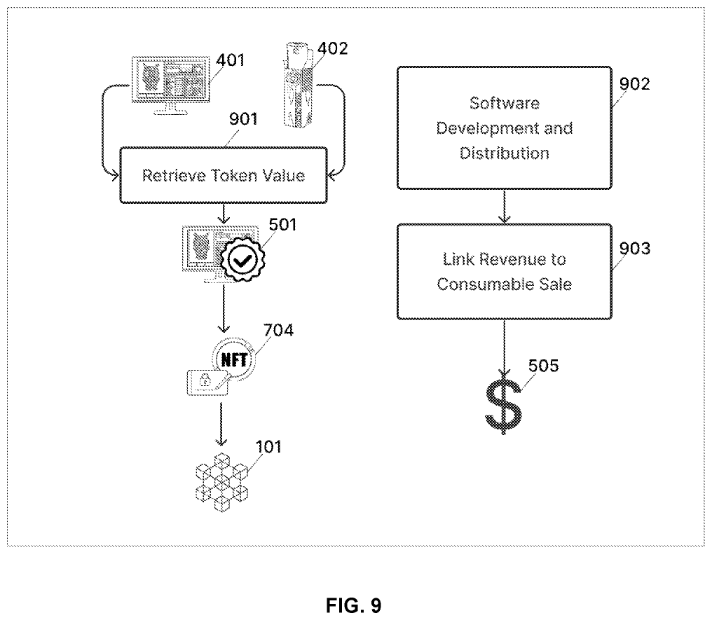

FIG. 9 is a schematic diagram showing an exemplary “SmartSupplySystem (SSS)” integrated by developers of software applications usable with consumable goods. The SSS may facilitate developers to certify their software, generate a digital signature and NFT stored on a blockchain, and link the software development licensing and distribution 902 to the distribution and sale of consumable items 903, creating an ongoing revenue stream 505. The SSS may be integrated by developers of software applications 401 that are usable in conjunction with various consumable goods 402. Software developers may integrate SSS, certify their software 501, and/or generate a digital signature and NFT 704, which may be stored on a blockchain 101. The SSS may incentivize software development and distribution 901 by linking the software development licensing and distribution 902 to the distribution and sale of consumable items 903. The SSS may thereby create a seamless and automated ongoing revenue stream 505.

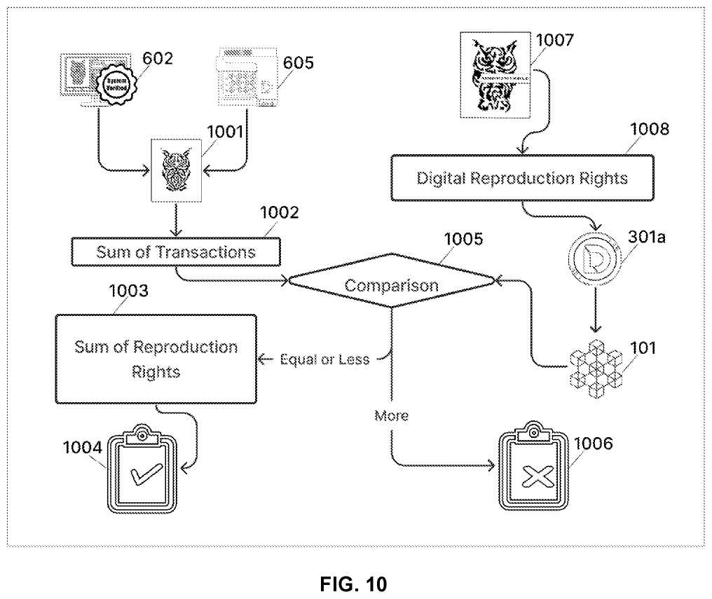

FIG. 10 is a schematic diagram illustrating an exemplary method for distribution of digital reproduction rights of intellectual property 1001 by linking 1004 and limiting 1006 the actual reproduction act as recorded by system-verified software applications to the consumable transactions, such as printed sheets of media. The distribution of digital reproduction rights 1008 of intellectual property 1007, such as copyrighted art, may be facilitated by linking 1004 and limiting 1006 the actual reproduction act, such as printing copies, as recorded by the “system verified” software applications 602 to the consumable transactions 605, such as printed sheets of media. Examples of printed sheets of media may include transfer paper, film, rolls of printable material, or any other type of printable substrate. The reproduction act may include printing directly to substrates such as garments or printing plates. The sum of these transactions 1002 may then be compared 1005 to the total sum for the reproduction rights 1003, as recorded in the form of an immutable crypto token 301a stored on the blockchain 101.

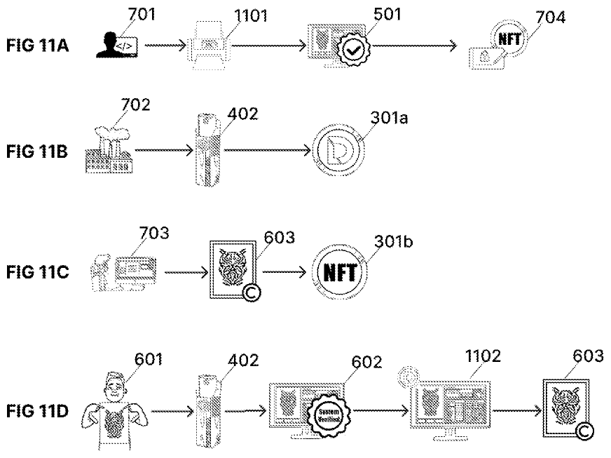

FIG. 11A is a schematic diagram illustrating an exemplary method for software certification through the issuance of a valid NFT and digital signature. Developers of software applications 701 may implement the SSS technology 1101 and submit the final software product for certification 501 through the issuance of a valid NFT and digital signature 704.

FIG. 11B is a schematic diagram illustrating an exemplary method for manufacturers or distributors submitting consumable goods for certification through the issuance of a valid crypto token. Manufacturers or distributors 702 of consumable goods 402 may submit each consumable-good type and quantity measure for certification through the issuance of a valid crypto token 301a.

FIG. 11C is a schematic diagram illustrating an exemplary method for intellectual property owners submitting digital IP for certification through the issuance of a valid NFT digital token. Intellectual property owners 703, such as artists, may submit digital intellectual property (IP) for certification 603 through the issuance of a valid NFT digital token 301b.

FIG. 11D is a schematic diagram illustrating an exemplary method for end-users purchasing consumable goods, procuring NFT-signed software, using a method of loading tokens to enable features as disclosed herein, and optionally purchasing digital reproductive rights to NFT-enabled IP. End users 601, who may consume any or all of the consumable items of FIGS. 11A, 11B, and 11C, may purchase the consumable goods 402, procure the NFT-signed software 602 for use with the consumable, use a method of loading the tokens to enable the features 1102 as disclosed herein, and optionally purchase digital reproductive rights 603 to NFT-enabled IP.

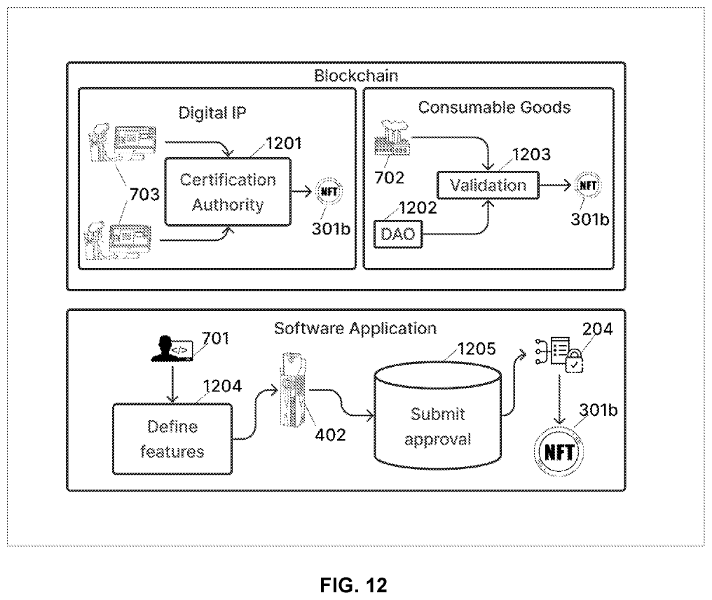

FIG. 12 is a schematic diagram showing an exemplary high-level system architecture diagram illustrating the various components of the system, including software applications 1204, consumable goods 702 and their certification 1202, and digital intellectual property rights 703, managed through blockchain technology 301b. The exemplary architecture, together with additional examples and variations thereof within the scope of this disclosure, provide a comprehensive system for managing the distribution, tracking, and authorization of software applications 1205, consumable goods 1203, and digital intellectual property rights 1201 using blockchain technology. The comprehensive system may facilitate a transparent, secure, and automated approach to managing these assets and interaction.

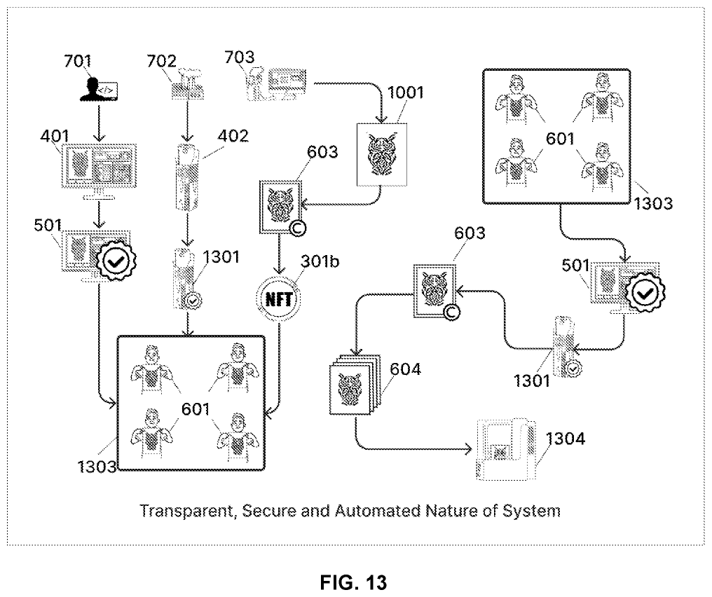

FIG. 13 is a schematic diagram highlighting exemplary processes and interactions between different stakeholders. Software developers 701 create software features and functions targeting the system advantages 401 and then receive certification of these features and functions 501 which enables them to utilize system distribution opportunities 1303. Consumable manufacturers 702 create consumables 402 and then receive certification attesting to the validity of the consumable claims 1301 which enables them to utilize system distribution opportunities 1303. Intellectual property owners 703 create IP 1001 and then receive certification of ownership 603 with a digital representation 301b which enables them to utilize system distribution opportunities 1303. End users 601 represent the system distribution opportunities 1303 acquiring certified software 501, certified consumables 1301, certified IP 603, to create the desired results 604 in a transparent, secure, and automated nature 1304.

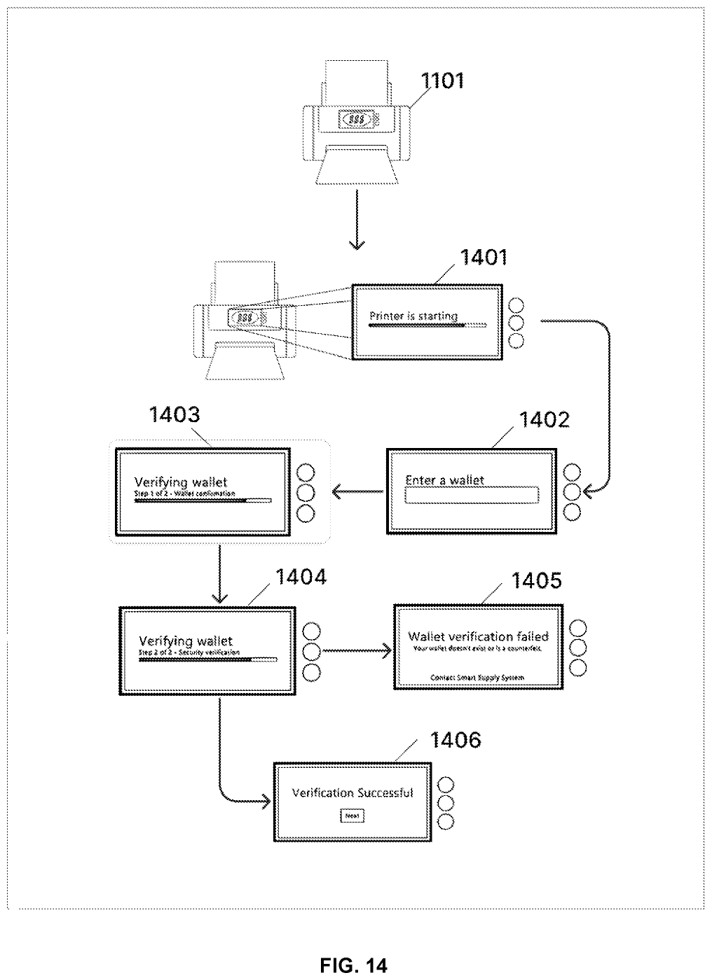

FIG. 14 is a schematic diagram depicting an exemplary SmartSupplySystem Software Development Kit (SSS-SDK) integrated with an embedded printer controller software. The SSS-SDK may check for the presence of valid crypto wallets (herein referred to as “digital wallets”) and if none are found, it may present a web-enabled window or dialog to the user, informing the user of the need for an SSS-compatible digital wallet to be installed. Upon initialization, the embedded printer controller software 1101 may wait for an “OK to run” response 1401 from the SSS-SDK technology. The SSS-SDK technology may first check for the presence of one or more valid digital wallets 1402, to then confirm the wallet represents a valid consumable token 1403, and that it was issued by a valid authority 1404, prior to final approval 1406. If none are found 1405, the SSS-SDK presents a web-enabled window or dialog to the user, informing them of the need for an SSS-compatible wallet to be installed.

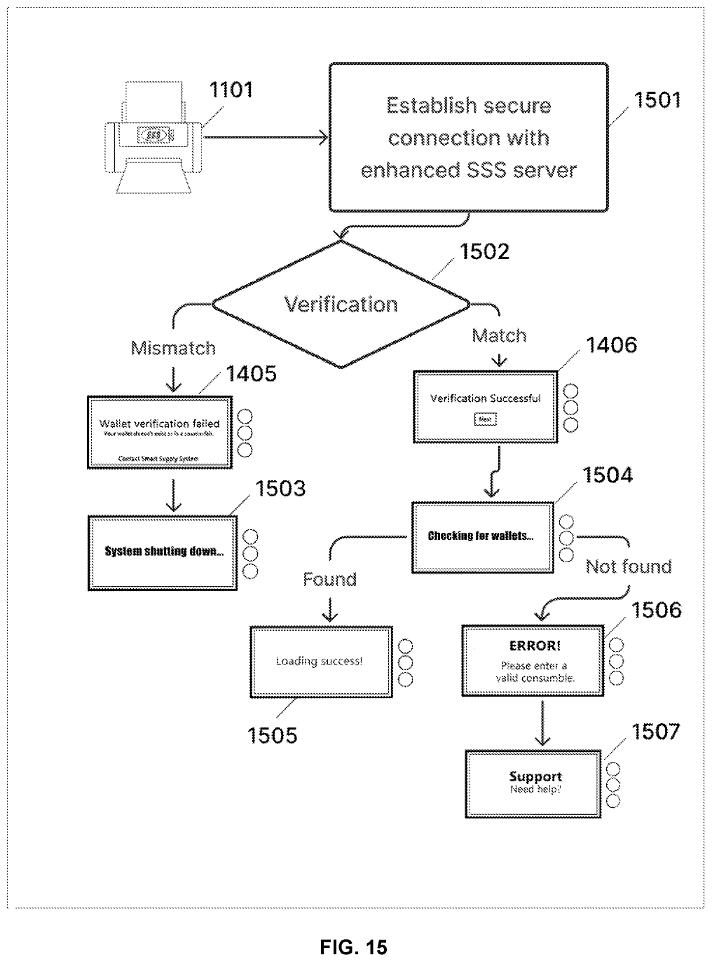

FIG. 15 is a schematic diagram illustrating an exemplary SSS technology establishing a secure connection with the Enhanced SSS Server, verifying the system OS-verified digital signature of the software, loading the digital wallet 1504 and data accounts, and checking for the presence of digital wallets containing valid crypto tokens for consumable products, with actions presented to the user through a web-enabled window or dialogue. The SSS technology 1101 may establish a secure connection with the Enhanced SSS Server 1501 and transmit the system OS-verified digital signature of the software for verification 1502. If the values do not match, a web-enabled window or dialog may be presented to inform the user of the counterfeit nature of the current software 1405 and then shut down 1503. Upon successfully validating the software 1406, the SSS technology may load the digital wallet 1505 and any data accounts containing the “system-verified” crypto token, which may provide information regarding transaction data storage. The SSS technology may then check for the presence of wallets 1504 containing valid crypto tokens for consumable products. If no valid consumable wallets are found, a web-enabled window or dialog 1507 may be presented to inform the user of the need for valid consumables to be installed and provide a method for this to be performed 1506.

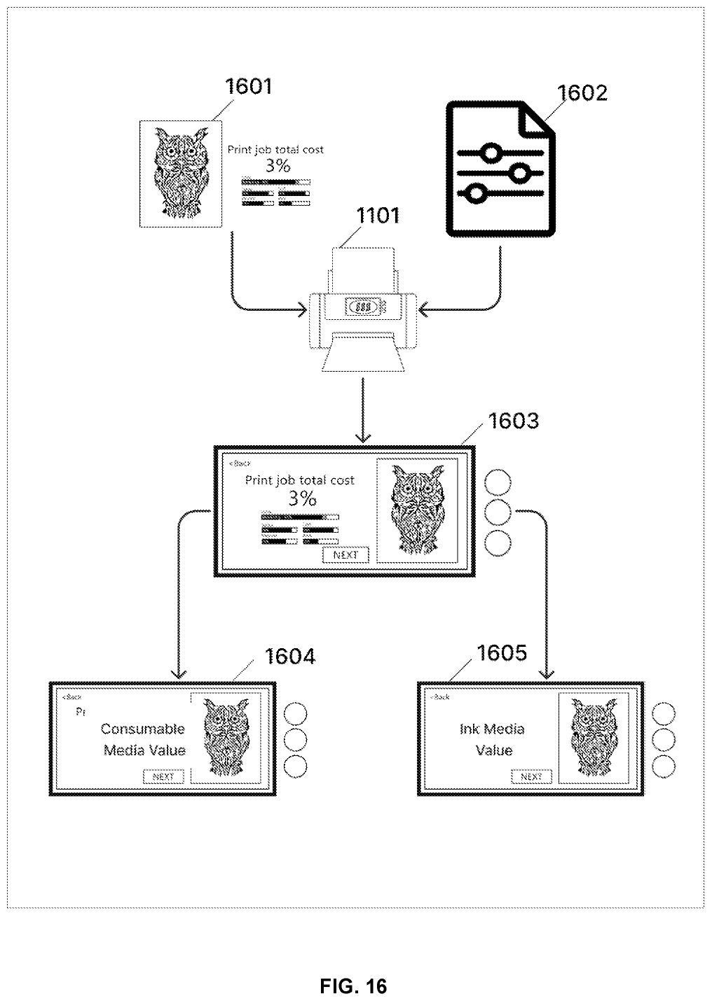

FIG. 16 is a schematic diagram illustrating an exemplary user's printing application 1101 as it sends fully rendered rasterized files 1601 of a print job, along with print control files 1602, to an embedded printer controller software 1101. The raster files may represent the consumable ink 1605, while the print control files may represent the consumable print media type, size, and number to print 1604. When ready to print, the user's printing application may send a fully rendered version of the print job as rasterized files 1601, along with print control files or information 1602, to the embedded printer controller software 1101. The raster files 1601 may represent the marks made using the consumable ink or toner and/or made onto the consumable media, such as transfer paper or film or rolls of printable material or any other type of printable substrate 1603. The print control files 1602 may represent the consumable media type and size and the desired number of copies to print.

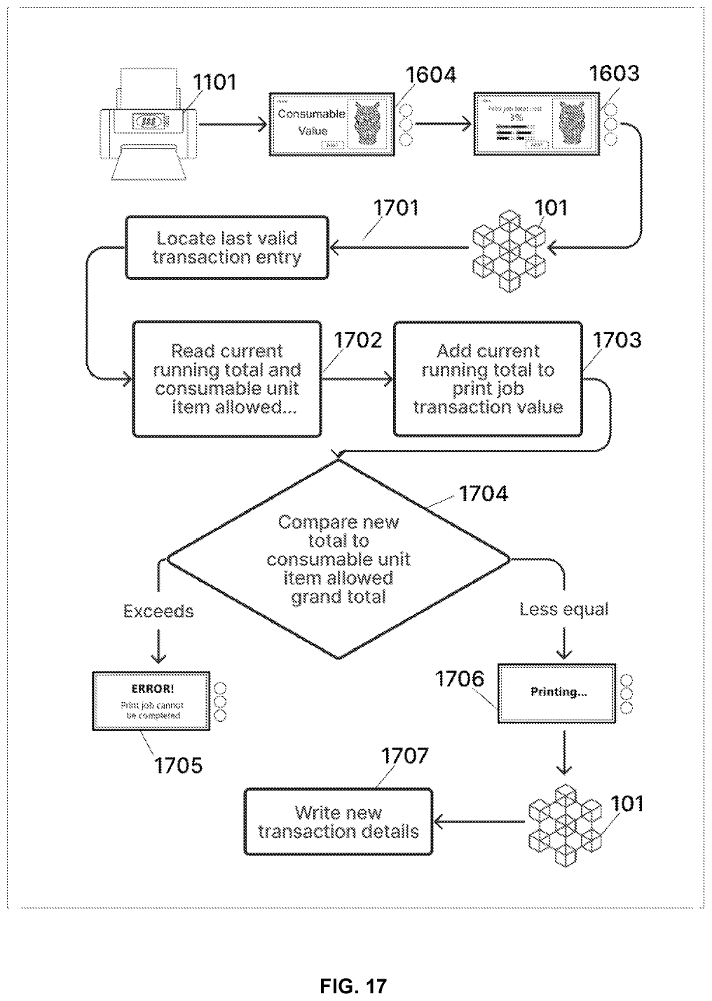

FIG. 17 is a schematic diagram illustrating an exemplary process on how an SSS-enabled printer controller software may calculate a consumable print job transaction by combining the details for each consumable item used, connect to the designated blockchain, and compare the new transaction details with the consumable unit item allowed grand total value to determine whether the print job may be completed or not. The SSS-enabled printer controller software 1101 may read the raster files and calculate the total consumable ink or toner and/or media per copy, then multiply this by the number of copies to obtain the consumable ink total value, repeating for each individual print page. The printer controller software may use the media type and size multiplied by the total copies to obtain the consumable media value 1604. The printer controller software may then report to the user various amounts of consumable items being used in the print job 1603.

The details for each consumable may be calculated from the print job and combined with additional and optional details, such as the software ID, timestamp data, TCP/IP address, location, and other potentially valuable information, to create a consumable print job transaction 1602. The SSS-enabled technology may connect to the designated blockchain or Immutable Distributed Transaction Storage System (IDTSS) 1603 and locate the last valid transaction entry for each consumable 1701. The SSS-enabled technology may read the current running total and the consumable unit item allowed grand total value stored in that transaction 1702.

The SSS-enabled technology may add the current running total to the print job transaction value, creating a new current running total value 1703, and compare this new total to the consumable unit item allowed grand total value 1704 for each consumable item. If any transaction's new current running total value exceeds the consumable unit item allowed grand total value, the SSS-enabled technology may present a web-enabled window or dialog informing the user that the print job cannot be completed 1705. If the new current running total is less than or equal 1706 to the consumable unit item allowed grand total value, the new transaction details containing the new current running total value, the consumable unit item allowed grand total value, and all other details 1707 may be appended to the blockchain 101 or IDTSS for each consumable item.

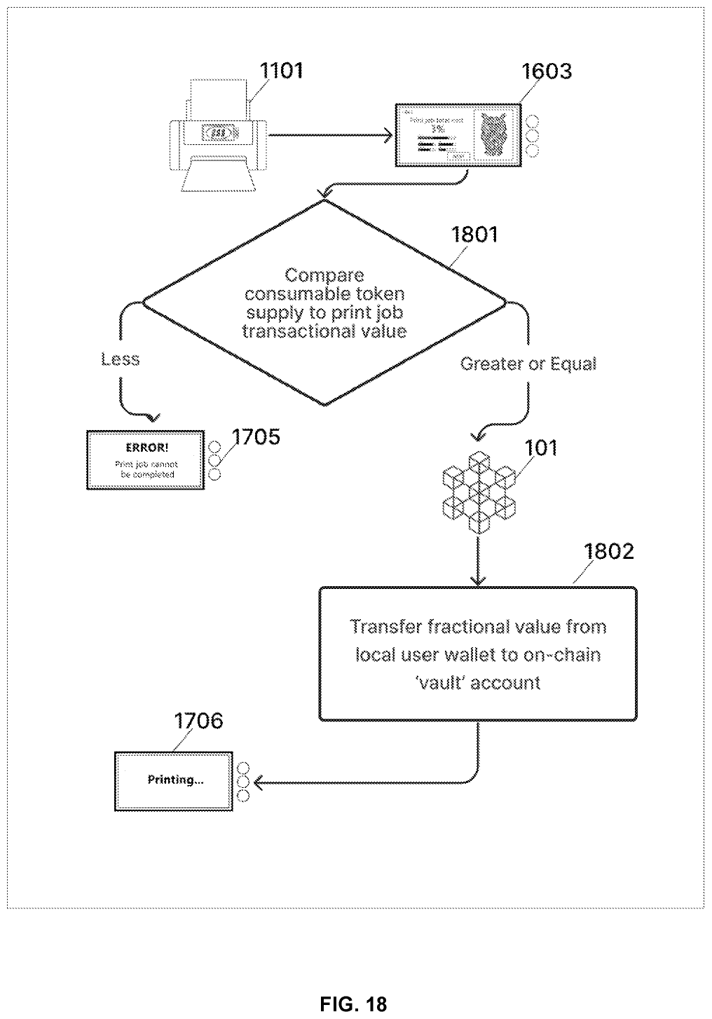

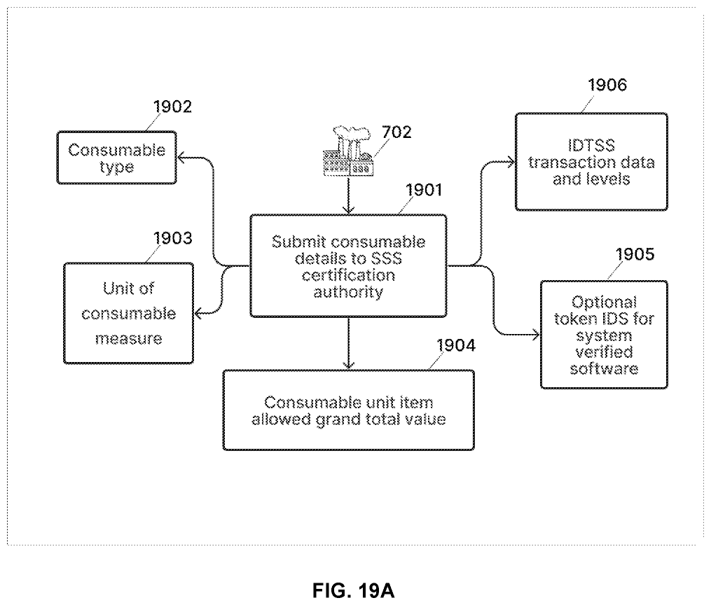

FIG. 18 is a schematic diagram illustrating an exemplary method in which the SSS-enabled technology 1101 calculates the print job transaction value and attempts to transfer the fractional value 1603 from the local user digital wallet to an on-chain ‘vault’ account using a Smart Contract, thereby reducing the local token supply. The SSS-enabled technology may send a transaction of the original consumable token value to a blockchain program 101 or Smart Contract to transfer the fractional value from the local user digital wallet to an on-chain ‘vault’ account, thereby reducing the local token supply 1802. If the local consumable token supply is less than the print job transaction value, then the transaction may fail and the print job may not be permitted to proceed; otherwise, the print job may be allowed 1801.

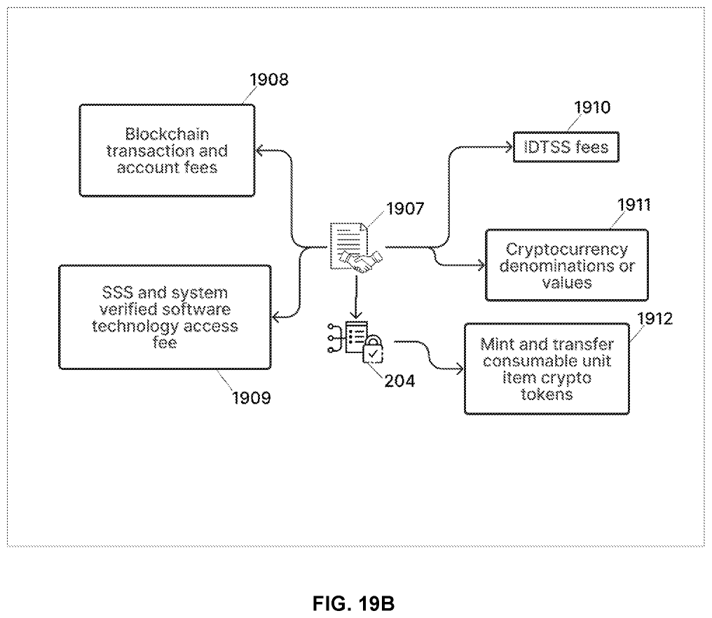

FIG. 19A is a schematic diagram depicting an exemplary method in which a manufacturer or distributor 702 of consumable goods submits details for specific types of consumable goods to the designated certification authority 1901 within the SSS system. These details may include information such as the identity of the consumable type 1902, the unit of consumption measure 1903, the consumable unit item allowed grand total value 1904, and optional token IDs for “system-verified” software 1905 to limit usage to approved software. Other details, such as IDTSS transaction data and levels, may also be included 1906.

FIG. 19B is a schematic diagram depicting an exemplary method in which a contract agreement 1907 is reached among all involved parties, utilizing standard business practices. This contract agreement 1907 may include the consumable item details mentioned with respect to FIG. 19A and may incorporate information regarding token name, symbol, total supply 1908, blockchain transaction and account fees 1909, SSS and “system-verified” software technology access fees 1910, IDTSS fees 1911, cryptocurrency denominations or values, and more 1912. The contract agreement 1907 may be recorded in a blockchain program or smart contract 204. This smart contract may be designed to receive designated cryptocurrency value from the manufacturer or distributor and mint and transfer consumable unit item crypto tokens into a specified wallet. The smart contract may be tailored for each distinct product type or accommodate multiple product quantity levels based on the cryptocurrency transaction value.

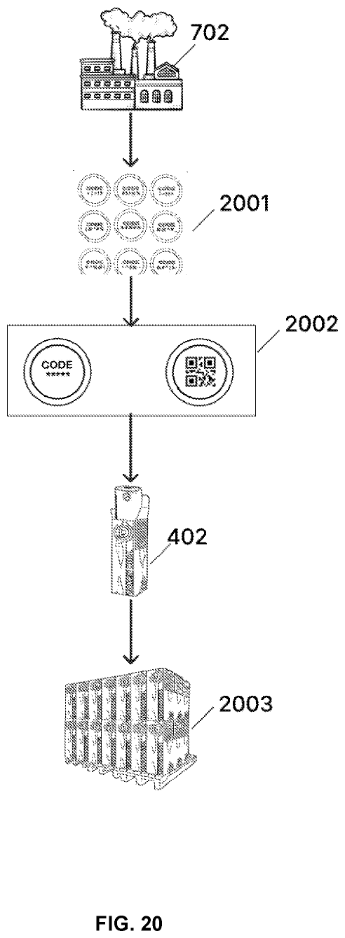

FIG. 20 is a schematic diagram illustrating an exemplary method for a manufacturer or distributor creating unique labels for consumable items. This process may include creating a label or identification system 2001 for use with the consumable product 402. Various identification methods 2002 may be used, including custom-designed and printed labels applied to the consumable before packaging, scratch-off labels on packaging, RFID labels, QR codes, coding systems linked to existing product serial numbers, laser-engraved inscriptions on the product, or any combination of unique identification systems to be used prior to final distribution 2003.

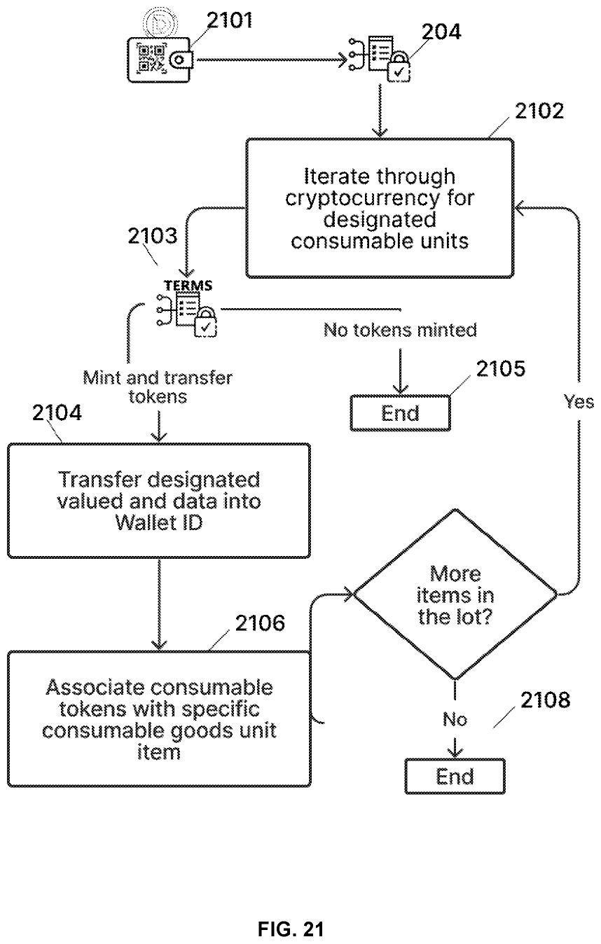

FIG. 21 is a schematic diagram showing an exemplary method for the creation of unique digital wallets and the transfer of cryptocurrency to a smart contract from these digital wallets to mint or transfer tokens and accounts according to the smart contract terms. The SSS system may include software to facilitate the creation of unique digital wallets (e.g., public/private keypairs or recovery phrases) 2101 and transfer designated cryptocurrency types, denominations, and/or amounts to the agreed-upon smart contract 204 from or with these unique digital wallets. The Smart Contract may iterate through the cryptocurrency which references a designated number of consumable units 2102, and for each unit, according to the smart contract terms 2103, tokens and accounts containing the designated values and data may be minted or transferred into the unique wallet ID 2104. The unique identification (e.g., public/private keypair or recovery phrase) of this digital wallet may then be used in the process to associate the consumable tokens with the specific consumable goods unit item 2106. This process may be repeated for every item in a given lot, shipment, production, or packaging designation 2107 of consumable goods, facilitating integration at any point in the production-to-sale system with minimal disruption to existing distribution methods while providing a secure and reliable solution per the terms of the agreement 2105.

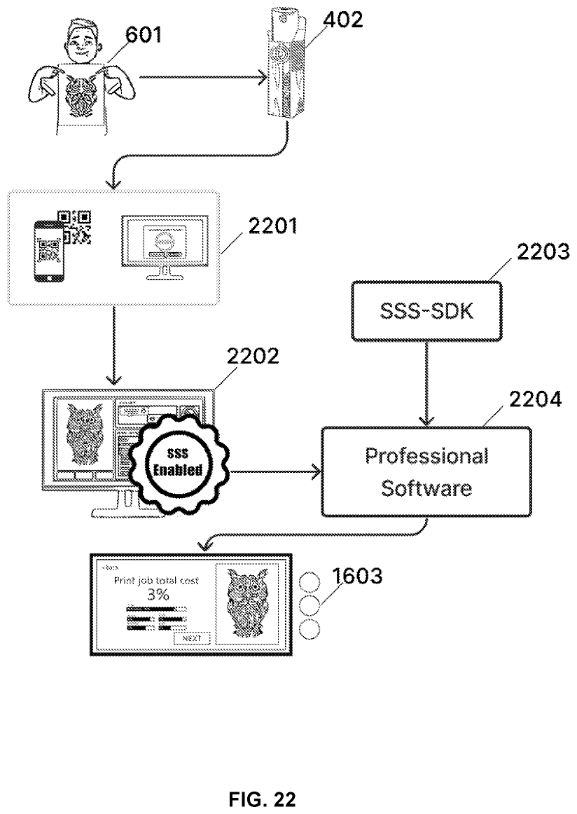

FIG. 22 is a schematic diagram illustrating an exemplary process to register SSS-verified consumables with the SSS-enabled software. The SSS-SDK 2203 may be integrated with professional software 2204, for example, print production software commonly known as a “RIP,” used for preparing artwork for final output to raster imaging devices like printers, platemakers, or engraving machines. When users 601 purchase SSS-enabled consumables 402 for these devices, they may follow the process described in FIG. 22 to scan or enter the code, phrase, or ID 2201 into the SSS-SDK-enabled software 2202, registering the SSS-verified consumable with the SSS-enabled software and enabling desired features and functionality. Once the SSS technology 2203 is enabled, the professional software 2204 may operate to calculate consumable consumption 1603. For example, RIP software in conjunction with the SSS technology 2203 may operate to calculate consumable consumption 1603 based on its own raster data coverage of ink or toner, media usage based on its page setup values, and/or the total current transaction value derived from multiplying the above by the user-defined number of copies. In other examples, the professional software 2204 may perform analogous functions in other technology domains and industries by utilizing the SSS technology 2203.

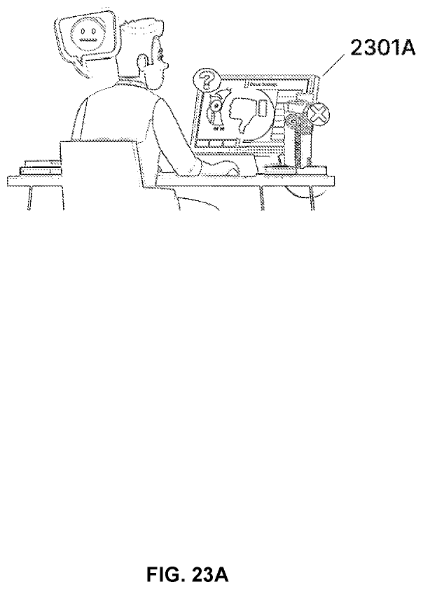

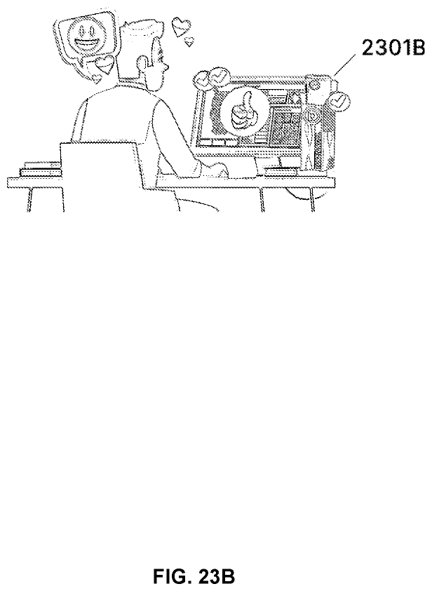

FIGS. 23A and 23B are illustrations showing how exemplary SSS technology may provide users with a more comprehensive and tailored experience by enhancing the functionality of professional software, such as a RIP, by triggering the authorization of numerous new features with the addition of SSS-enabled consumables. The SSS-SDK-enabled software may operate in multiple modes using this technology. The professional software, or RIP in this example, may provide minimal functionality when non-SSS-enabled consumables are in use 2301A. This would facilitate the software to accommodate a wide range of users. However, with the addition of SSS-enabled consumables, the SSS system may trigger the authorization of numerous new features, including features of the main software and features introduced by the SSS technology itself 2301B. This enhanced functionality may offer users a more comprehensive and tailored experience when using SSS-enabled consumables with their professional software or RIP.

### SmartSupplySystem Software Immutable Distributed Transaction Storage System Implementation

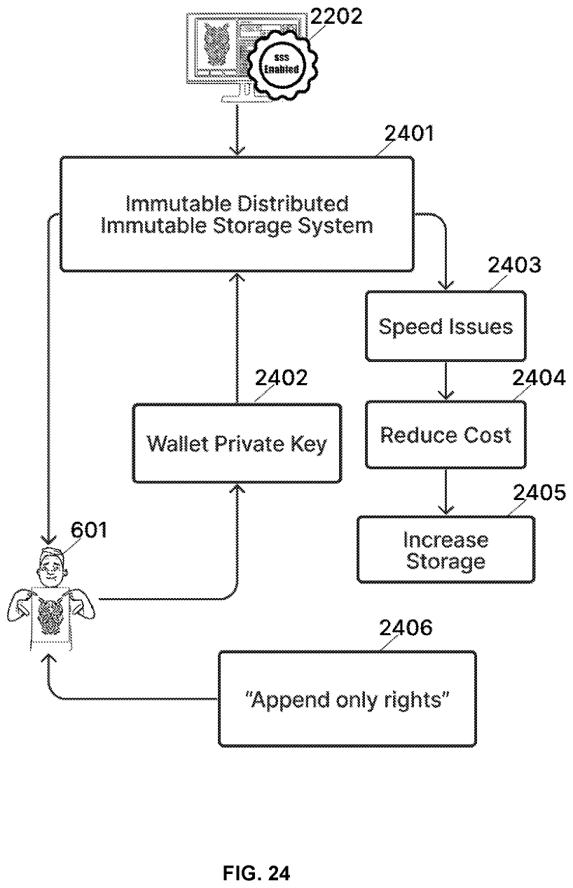

FIG. 24 is a schematic diagram illustrating an exemplary Immutable Distributed Transaction Storage System (IDTSS) 2401 during an initial phase of consumable or digital IP token configuration, storage of details on the blockchain, and structure of the IDTSS, including a distributed peer-to-peer network storage system connected to an immutable database system. The SSS-SDK-enabled software may employ an IDTSS to alleviate speed issues 2403 associated with typical blockchains, reduce transaction costs 2404, and provide storage for both large numbers of micro-transactions and larger files 2405, for example, high-resolution digital artwork files, in a secure and unalterable manner. The IDTSS may be established during an initial phase of consumable or digital IP token configuration, and details of the IDTSS may be stored in the account details on the blockchain. The IDTSS may include a distributed peer-to-peer network storage system connected to an immutable database system, where client accounts may be assigned “Append Only” rights 2406. By using the private key 2402 of the consumable digital wallet to encrypt transactions and the public key to index them, fast and secure access may be achieved. The consumable token ID may be added to track multiple consumables. Consumable-oriented software may access the IDTSS and seek the most current transaction for calculations.

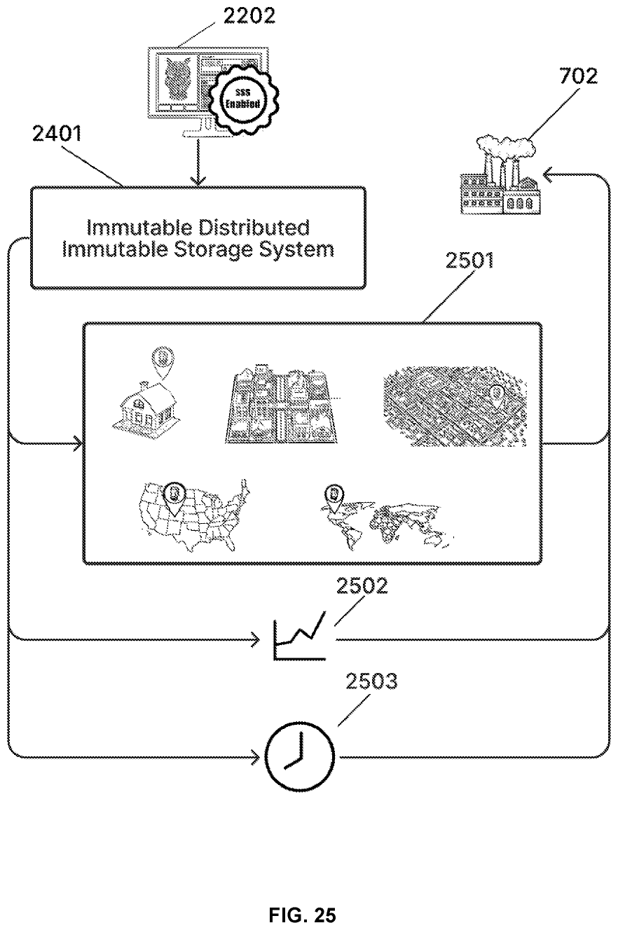

FIG. 25 is a schematic diagram illustrating an exemplary method for manufacturers or distribution parties to access the IDTSS 2401 to gain business intelligence 2501-2503. SSS-SDK-enabled software 2202 may be used by manufacturers or distribution parties 702 to access the IDTSS 2401 in an amalgamated fashion to gain product business intelligence regarding distribution and usage. Various types of transaction details may be collected, including geographical 2501, time 2502, and usage patterns 2503. This transaction information may be analyzed to provide valuable insights that can help predict inventory needs, optimize supply chain management, and improve overall business operations.

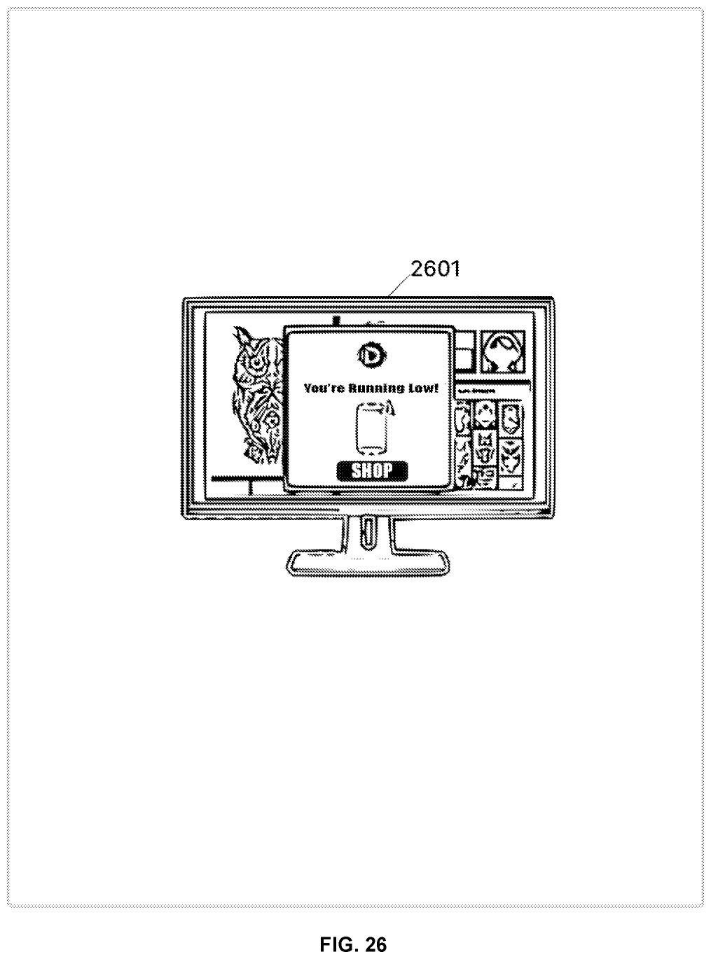

FIG. 26 is an illustration showing an exemplary SSS-SDK-enabled software used to monitor consumable levels and trigger events, for example, prompting the user to buy more consumables. SSS-SDK-enabled software may be used by manufacturers or distribution parties to access the IDTSS in a transaction-monitoring manner to trigger events based on various conditions, for example, low consumable levels. This may facilitate the manufacturer's system to initiate events on the consumer-enabled system, for example, notifying the user to “Shop Now Before You Run Out!” 2601.

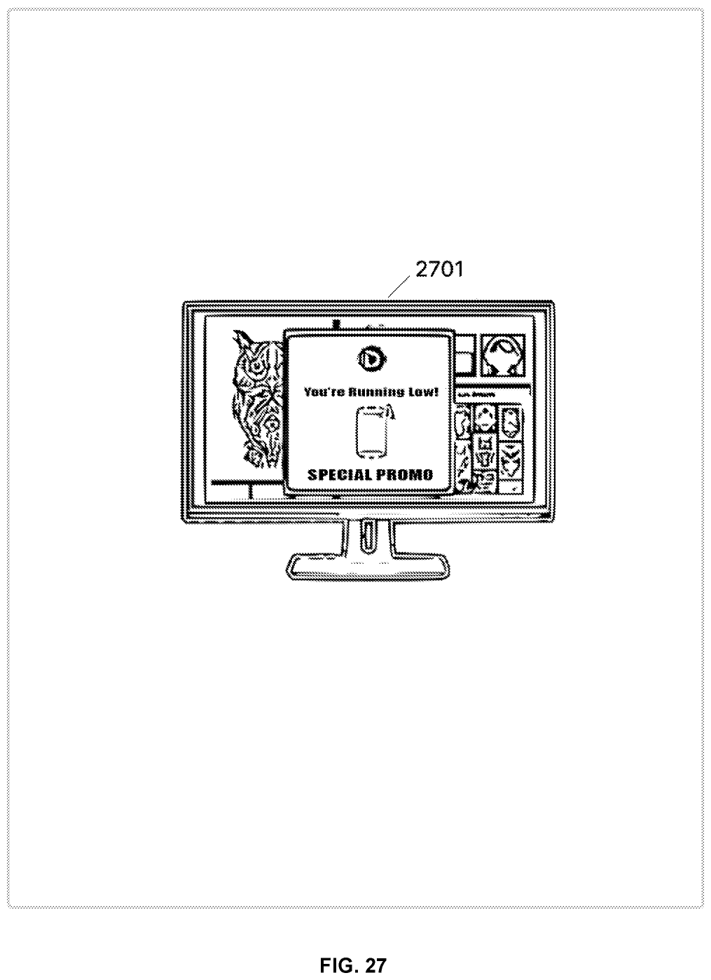

FIG. 27 is an illustration showing an exemplary method of triggering special offer events for users based on various conditions. Other examples include triggering special offer events 2701 for users of specific product types or in specific areas, those who haven't used the consumable in a certain time period, large volume users, or any combination of potential conditions.

### Digital Rights Management Using Crypto Tokenized Print Packages

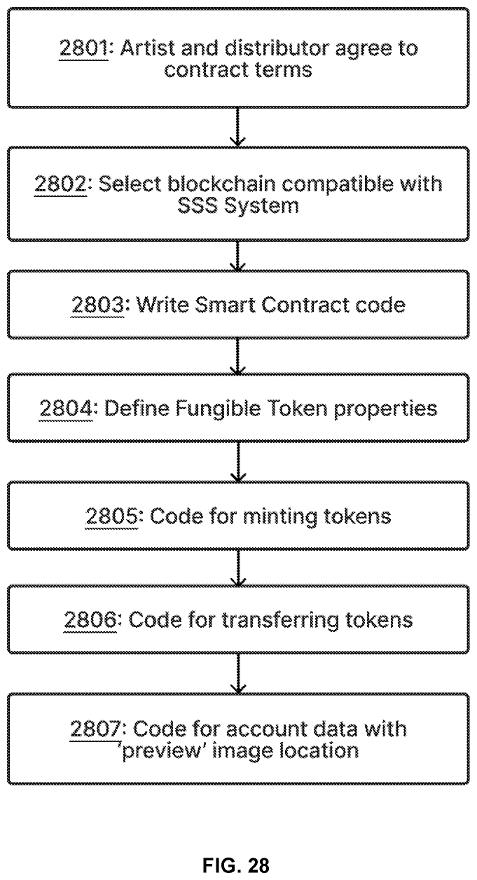

FIG. 28 is a flowchart illustrating exemplary groups or categories of digital IP as Crypto Tokenized Print Packages, which may exist as Smart Contracts on the blockchain. While Crypto Tokenized Print Packages may typically be configured for individual pieces of art, they may represent groups or categories of digital IP, as well.

In an operation 2801, an artist (IP creator) and distributor may agree to terms of a contract for the distribution of preview images. The contract may have a limited total supply value representing distribution to a segment of consumable item consumers for market intelligence purposes, for example, special pricing for print purchases or other market measuring statistics. A blockchain that is compatible with the SSS system may be selected in an operation 2802. The Smart Contract code may be written in an operation 2803 to define a special Fungible Token's properties (e.g., ERC-20), such as its name, symbol, and the agreed-upon quantity (operation 2804). The Smart Contract code may include code for minting of these tokens (operation 2805), for transfer of the tokens from one digital wallet to another (operation 2806), and for account data with the “preview” image location (operation 2807).

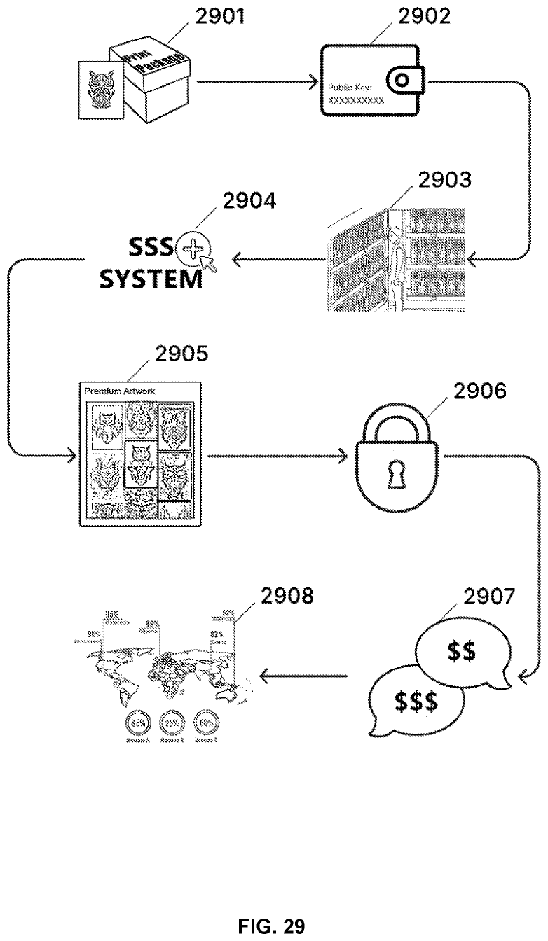

FIG. 29 is a schematic diagram showing an exemplary method for installing the Crypto Tokenized Print Packages either directly using existing digital wallets or through the ‘Master’ Smart Contract during an initial digital wallet creation phase, linking the purchaser of the consumable to the Print Package token and providing a distribution reference for each token. Crypto Tokenized Print Packages may be installed either directly using existing digital wallets or by the ‘Master’ Smart Contract 2901, which may install one or more digital preview packages to a new consumable digital wallet during an initial wallet creation phase, using the unique wallet public key, which then links the purchaser of the consumable to the Print Package token 2902. This may provide the artists or manufacturers with a distribution reference for each token 2903. The addition of these digital preview packages represents a value-add to the overall SSS system 2904, facilitating end users to have an integrated method of selecting artwork for projects 2905, artists to have a simple and automated way to securely present their artwork to a consumer base likely to purchase print rights 2906, manufacturers and distributors to have the ability to negotiate discounted print pricing with artists 2907 giving users a further incentive to purchase their consumables, and everyone to have high levels of business intelligence via the digital preview packages for further optimization and ROI calculations 2908.

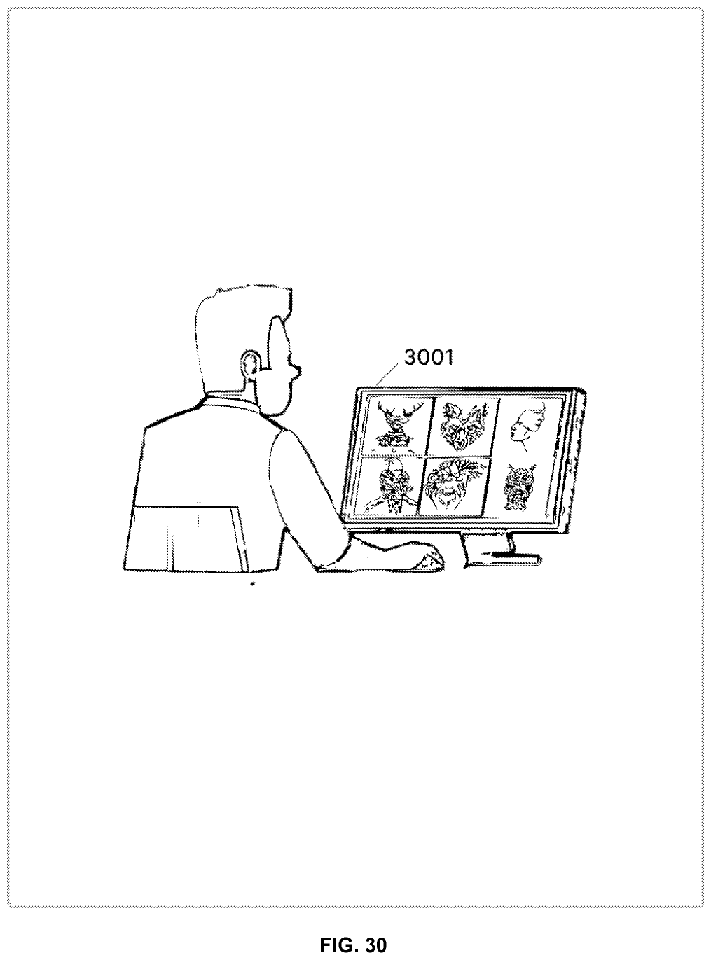

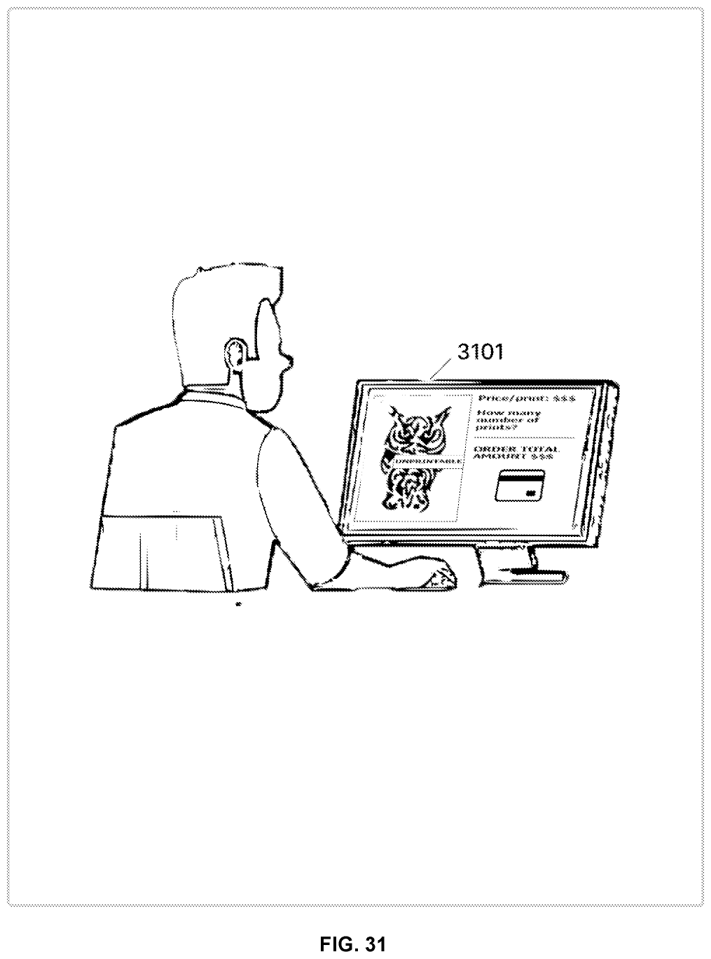

FIG. 30 is an illustration showing an exemplary method for securely enabling print rights orders. The process may begin with an end user placing an order for print rights through a predetermined method of purchase 3001, such as an online ordering system. The order may include, among other requirements, the public key of the consumable digital wallet and the unique identifier for the artwork token.

FIG. 31 is an illustration showing an exemplary system and method for securely purchasing and printing 3101 limited rights digital artwork using blockchain technology and SSS-enabled software. The system may include an online shopping system that integrates with the SSS-enabled software, facilitating a buyer to select a desired image from a showcase of unusable watermarked images and place an online order. The buyer may first be authorized on their credit card to make the purchase. The buyer may have a validated SSS blockchain digital wallet with several tokens and accounts for the purpose of validating and authorizing the purchase.

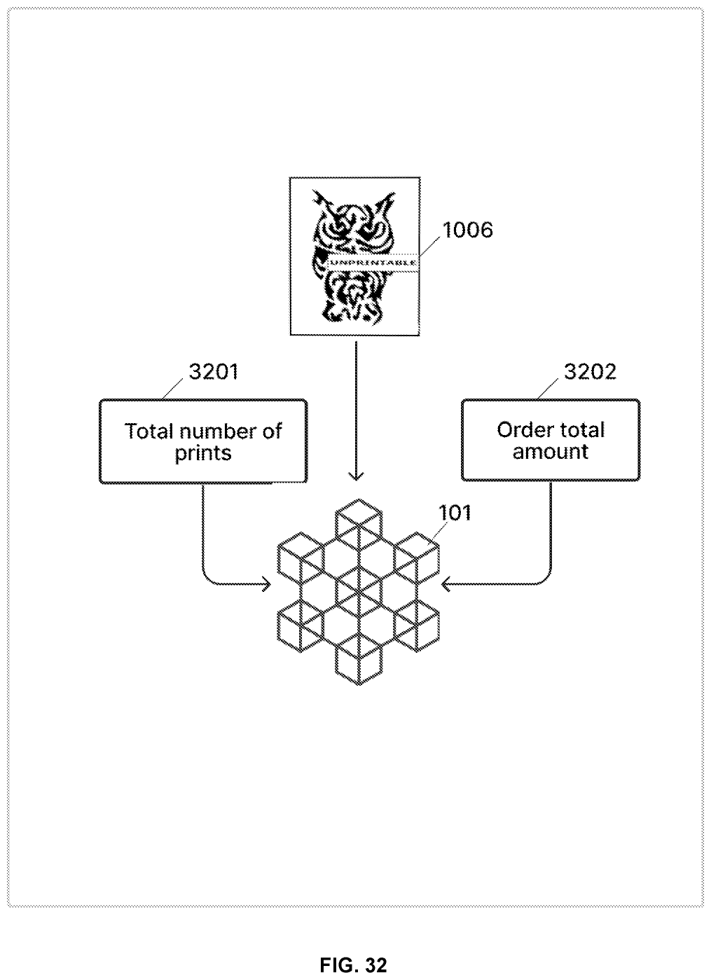

FIG. 32 is a schematic diagram showing an exemplary successful completion of an online order for digital artwork using the SSS-enabled software, in which a transaction is sent to a blockchain Smart Contract containing information about the artwork token and the number of authorized prints. The online ordering system may process the order, and upon successful completion, send a transaction to a blockchain 101 Smart Contract. The Smart Contract may include information used to mint Authorized Tokens corresponding to the artwork token and the number of authorized prints 3201. The Smart Contract may then generate Authorized Tokens corresponding to the artwork token and in the amount of the number of authorized prints 3202 into the buyer's consumable digital wallet.

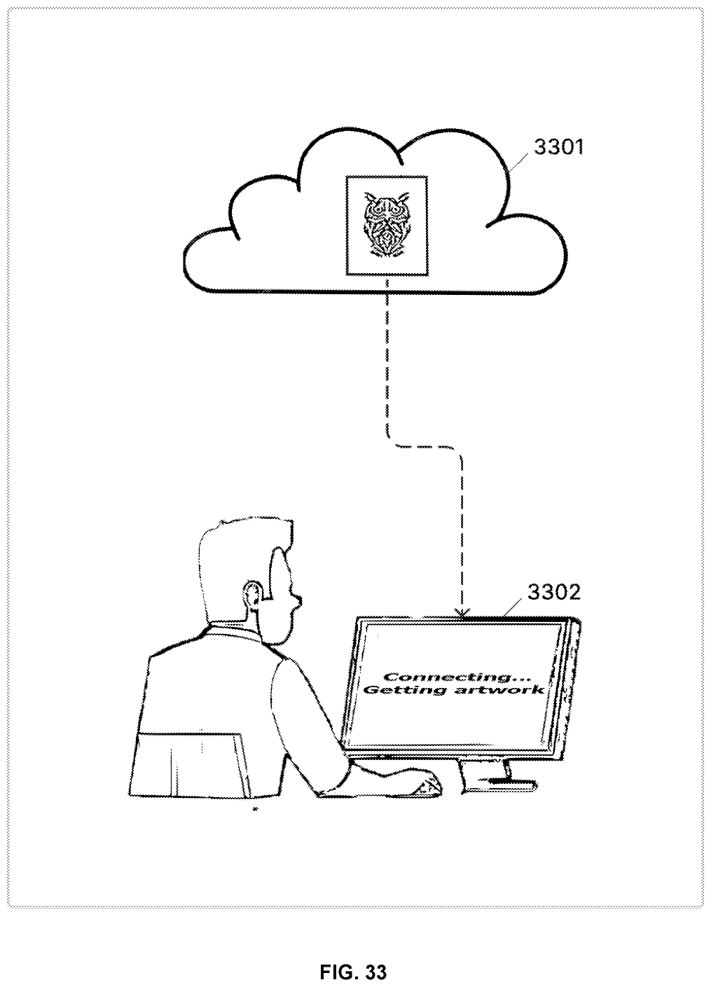

FIG. 33 is a schematic diagram illustrating an exemplary SSS-enabled software establishing a secure connection with a SSS-enhanced centralized server with the relevant information and tokens corresponding to the artwork as well as the authorized number of prints from the blockchain transaction. The SSS-enabled software may detect the Authorized Token and connect 3302 to a special SSS-enhanced centralized server 3301 using a verified secure connection. The SSS-enabled software may then obtain the look-up code for the original from the transaction, along with the relevant details and Authorized Tokens corresponding to the artwork and the number of authorized prints, and present this data to the SSS-enhanced Escrow server to remotely load the printable data.

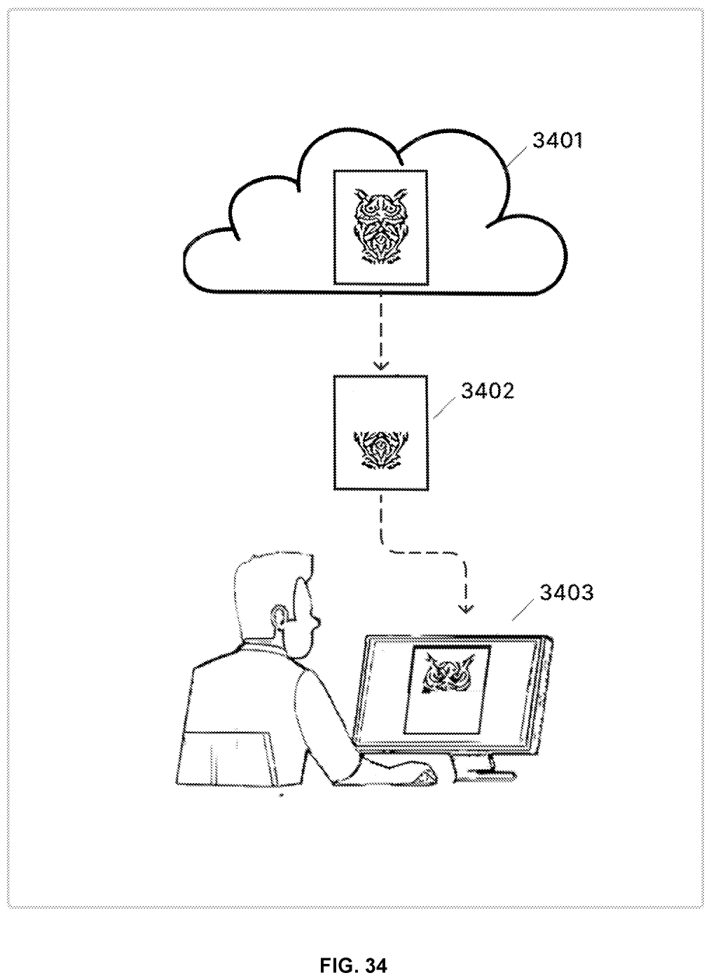

FIG. 34 is a schematic diagram depicting an exemplary SSS-Enhanced server establishing a secure connection to the Verified SSS-enabled software through SSL/TLS protocols. The SSS-Enhanced server 3401 may establish a secure connection to the Verified SSS-enabled software using Elliptic Curve Diffie-Hellman protocols, for example, SSL/TLS. The server may read the original image data from the source provided in the look-up table and securely transmit 3402 it to the memory buffer provided by the SSS-enabled software 3403.

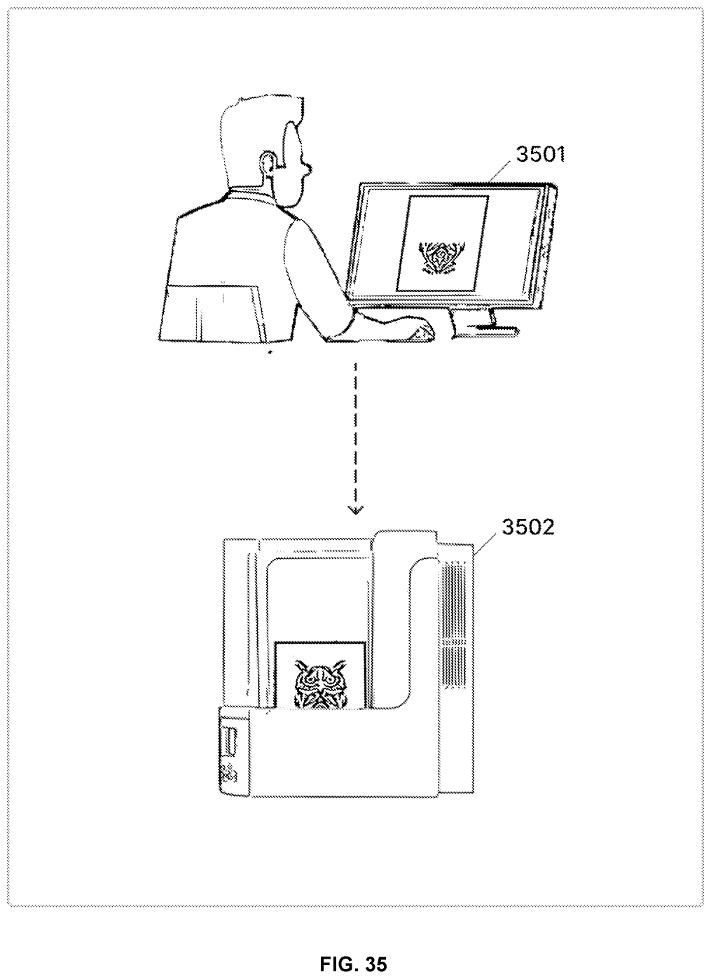

FIG. 35 is a schematic diagram illustrating an exemplary verified consumption of consumables to limit the total number of prints. The SSS-enabled software may use the verified consumption of consumables 3501 to control and limit the total number of prints 3502. Prior to or at the completion of each individual print, the SSS-enabled software may send a transaction to another blockchain Smart Contract with an Authorized Token. The Smart Contract may then generate a corresponding Used Token into both the buyer's and seller's digital wallets. The seller may then confirm and collect the authorized credit card charge for the transaction.

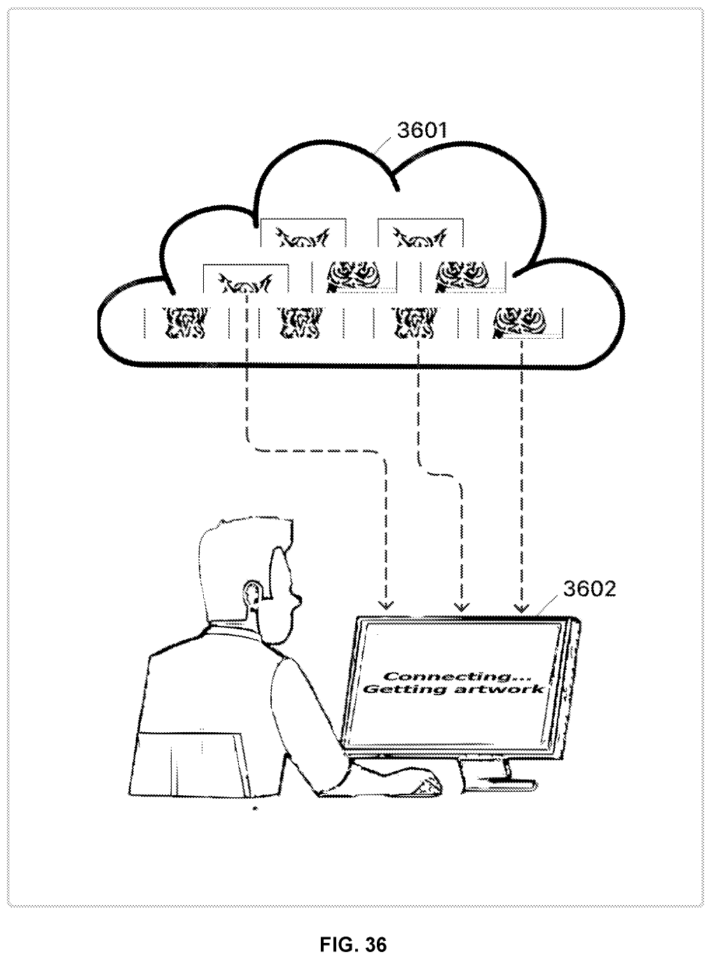

FIG. 36 is a schematic diagram illustrating an exemplary distributed quantity of shares for reconstruction of the original artwork 2603, thereby protecting against unauthorized access and data loss or corruption. The original digital artwork may be divided into n shares 3601, where k out of n shares may be a threshold quantity for reconstruction of the original artwork. The shares may be distributed across multiple storage devices or servers for protection against data loss or corruption. The use of threshold secret sharing facilitates protection of the digital artwork from unauthorized access, even if one or more of the storage devices or servers is compromised.

### Digital Rights Management Using Consumable Token Print Transactions

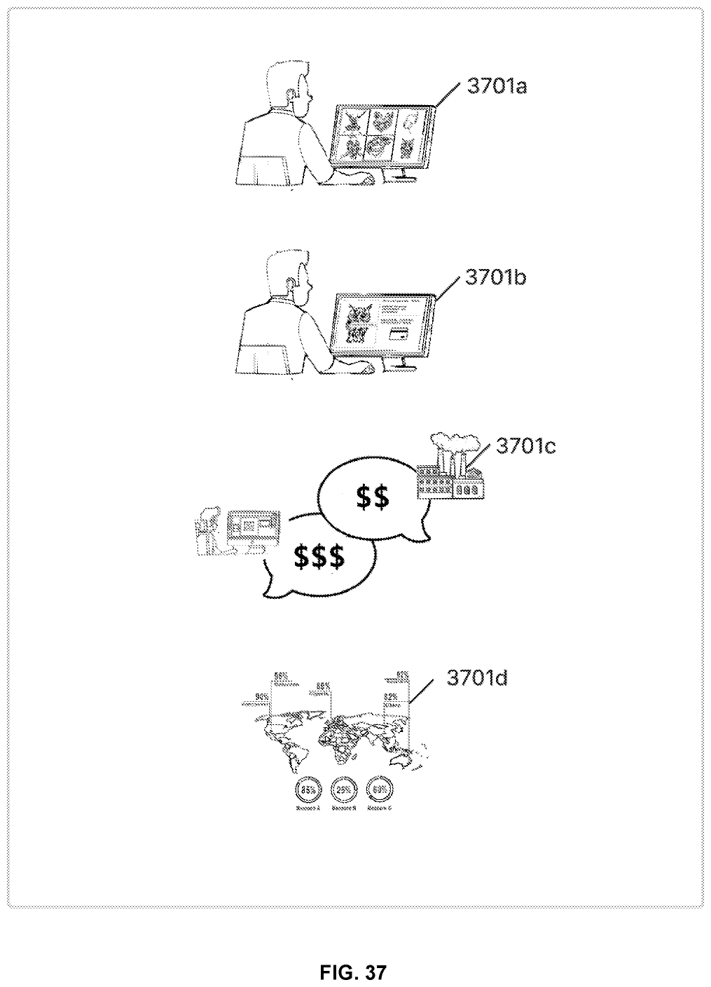

FIG. 37 is an illustration representing exemplary value-added features of the SmartSupplySystem. The use of blockchain technology and SSS-enabled software may facilitate protection of the digital artwork from unauthorized copying and distribution. The system may be efficient and convenient for buyers, who may thereby purchase and print digital artwork without worrying about piracy concerns. The use of blockchain technology may facilitate low transaction costs for both buyers and sellers, making the system affordable for a wide range of users. Finally, the system may be scalable, facilitating use for large-scale digital artwork purchases and printing.

The exemplary value-added features illustrated include:
a. An integrated method for end users to select artwork for projects (3701a).
b. A simple and automated way for artists to securely present their artwork to a consumer base likely to purchase print rights (3701b).
c. Manufacturers and distributors having capabilities to negotiate discounted print pricing with artists, giving users a further incentive to purchase their consumables (3701c).
d. High levels of business intelligence for everyone involved, facilitating further optimization and ROI calculations (3701d).
   These features highlight the benefits of incorporating digital preview packages into the overall SSS system, enhancing the experience for end users, artists, manufacturers, and distributors.

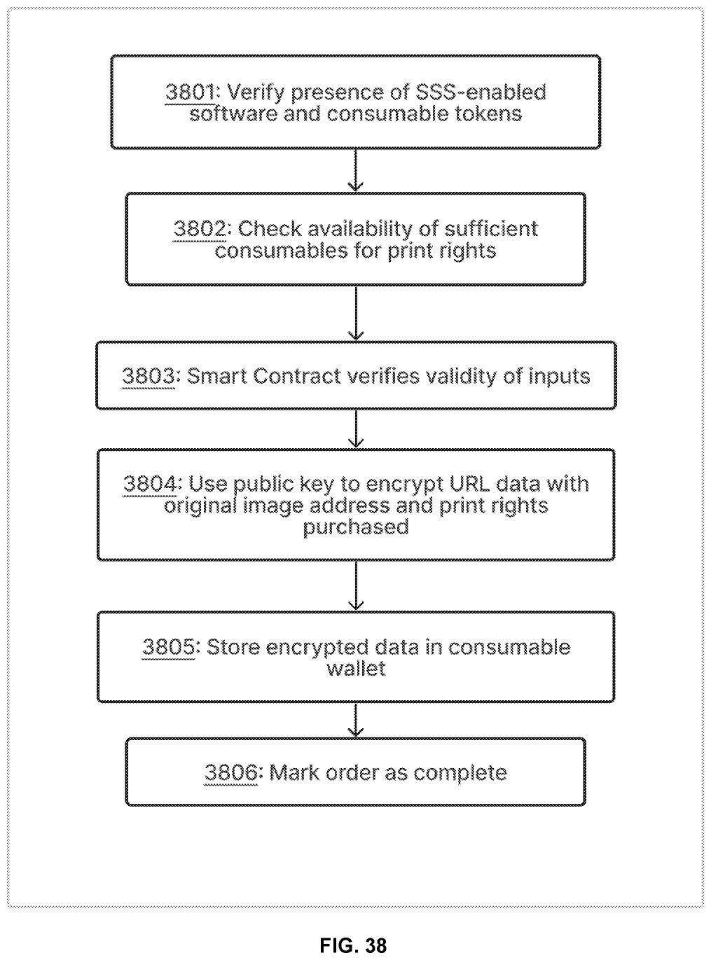

FIG. 38 is a flowchart depicting an exemplary method for a Smart Contract verifying inputs including the presence of SSS-enabled software and consumable tokens, as well as the availability of sufficient consumables to cover the print rights being granted. The Smart Contract may verify the validity of inputs (operation 3803), including the presence of SSS-enabled software and consumable tokens in the consumable digital wallet (operation 3801), as well as the availability of sufficient consumables to cover the quantity of print rights being granted (operation 3802). The Smart Contract may then use the public key of the consumable digital wallet to encrypt the URL data with the address of the high-quality original image and the quantity of print rights purchased (operation 3804). This encrypted data may be stored in the consumable wallet (operation 3805), and the order may be marked as complete (operation 3806).

In summary, this exemplary method may securely facilitate and/or authorize print rights orders by deploying a Smart Contract on the blockchain that verifies the validity of inputs (operation 3803), encrypts the URL data containing the address of the original image and the quantity of print rights (operation 3804), and stores the encrypted data in the consumable digital wallet (operation 3805).

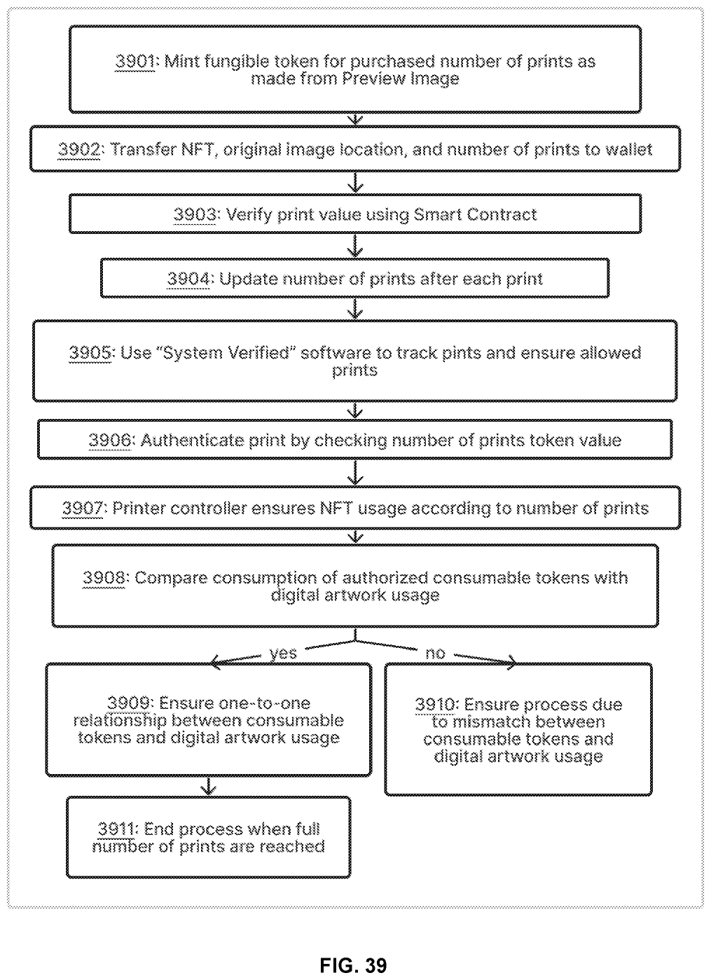

FIG. 39 is a flowchart depicting an exemplary method for securely managing the transfer of an original artwork non-fungible token, a corresponding original image location, and a fungible print rights token to a digital wallet using a smart contract on a blockchain platform. The fundamental concepts illustrated by the exemplary method illustrated in FIG. 39 may be applied in the context of other technologies and industries without departing from the scope of the present disclosure, for example, within the fields of artificial intelligence, machine learning, deep learning, artificial neural networks, deep neural networks, natural language processing, machine vision, data encryption, cybersecurity, etc. For example, artwork in the example of FIG. 39 may be substituted with any digital item having value in other examples, such as tokens representing usage rights in artificial intelligence systems.

The method illustrated in FIG. 39 may involve managing the transfer of a token minted as representing the purchased quantity of print rights (operation 3901) and a unique (non-fungible) token representing an original image location based on the purchase from a corresponding preview image location (operation 3902) using IDTSS, to an SSS-enabled digital wallet. The original image token may be a non-fungible token that references a printable original image of the artwork, which may be located in the IDTSS. The method may include the operations of minting a non-fungible token, representing a specific piece of artwork, and transferring the non-fungible token, the corresponding original image location, and the token representing the number of print rights to a digital wallet (operation 3902). The method may also include the operations of verifying the value of the printing to determine if the fungible print rights token has sufficient print rights value and updating the print rights after each print is made (operation 3903).

The method of FIG. 39 may be implemented using a smart contract deployed on a blockchain platform and may be interacted with using a blockchain program or Smart Contract. The smart contract may be designed to use the non-fungible token to reference the original artwork. The smart contract may include functions to burn or spend the print rights token to decrement the value of print rights after each print is made in a one-to-one relationship with a valid consumable token unit (operation 3904).

In addition, the method may include use of a “System Verified” software that uses a crypto token connection to consumable items as they are printed to ensure the artwork is only printed the exact allowed quantity of times and to keep track of the quantity of prints up to the permitted amount (operation 3905). The “System Verified” software may verify the authenticity of the print by checking the value of the print rights crypto token (operation 3906), which may be used by the printer controller to ensure that the original art non-fungible token is used in accordance with the print rights (operation 3907) represented by the fungible token in a one-to-one relationship with a corresponding unit of a consumable token (operation 3909).

The method of FIG. 39 may provide secure and efficient management of the transfer of a unique token representing a specific piece of artwork, the corresponding original image location, and the print rights token to a digital wallet. The method may be implemented using a smart contract deployed on a blockchain platform and may include a mechanism to prevent the non-fungible token from being used for more prints than the print rights token value through the “System Verified” software (operation 3908), which may provide an otherwise missing layer of security by verifying the authenticity of the printing software (operation 3905) and tracking the actual number of prints up to the allowed amount by measuring the tokenized consumables (operation 3910) and ending the process when the maximum number of print is reached (operation 3911).

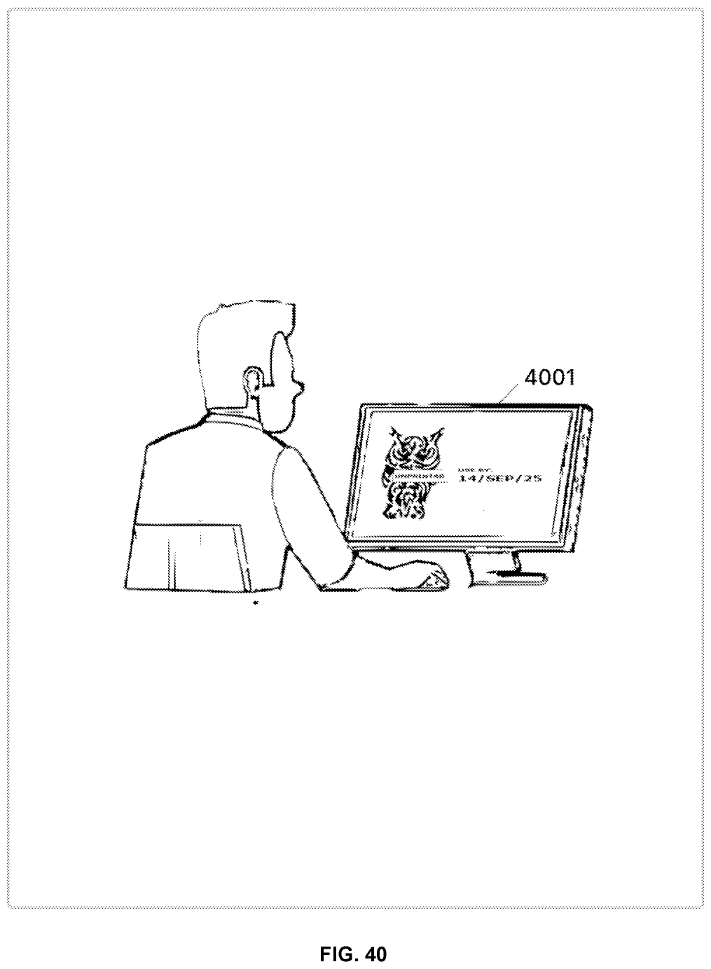

FIG. 40 is an illustration showing an exemplary additional capability of facilitating artists to set an expiration date for the crypto tokens 4001. As a result of the artists setting an expiration date for the crypto tokens, a consumer's ability to utilize the printing rights may expire after the designated time period indicated by the expiration date.

### Example Use Case

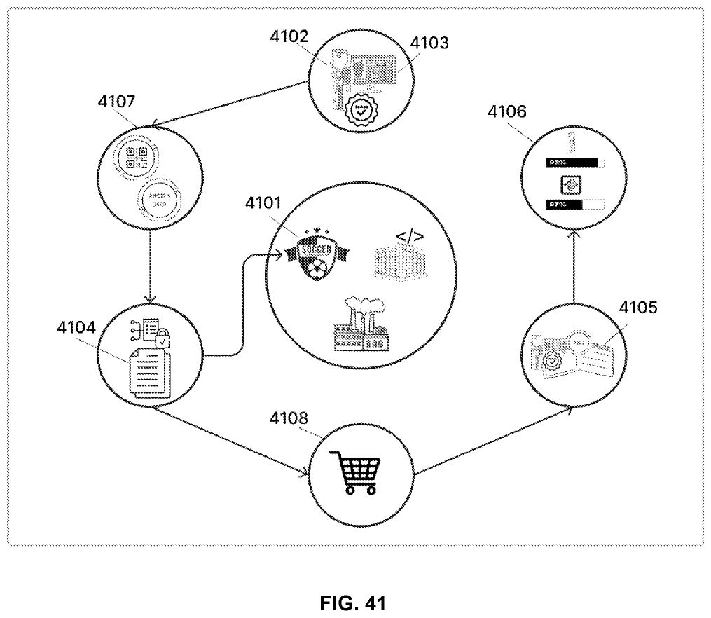

FIG. 41 is a schematic diagram illustrating an exemplary decentralized system that integrates the tracking and managing of consumable items, controlling software features, and managing digital rights through the use of DAOs, blockchain-based crypto tokens, digital wallets, and Smart Contracts. This decentralized system may securely connect the consumption of physical items to digital rights and software functions, improving the efficiency, reliability, and security of tracking and managing consumables across various industries, particularly in collaborations involving copyrighted material, trademarked products, and system-verified components.

As shown in FIG. 41, the exemplary decentralized system facilitates collaboration between a sports team with a copyrighted logo, a consumable manufacturer of print transfer media verified by a DAO, and a software company providing “system-verified” software for preparing artwork and printing it onto transfer-capable devices, also verified by a DAO. The system may employ item-type crypto tokens 4107, associated with unique digital wallet IDs and encoded into simple identifiers, such as phrases, ID values, or QR codes.

The process of using the system may be described as follows:
a. Verification: DAOs may verify the software 4103 and consumable print media 4102, to provide a trustless, transparent, and decentralized method for product validation.
b. Tokenization: Item-type crypto tokens may be created for the verified software 4103, the consumable print media 4102, and the copyright logo digital print rights 4101—each associated with a unique digital wallet ID.
c. Licensing: The copyrighted sports team logo's 4101 licensing terms may be defined within a Smart Contract 4104, specifying the conditions for using the logo, including the quantity of permitted prints and royalty payment terms 4104.
d. Purchase: Users and companies worldwide may purchase the verified software, verified media, and a verifiable quantity of print rights to the logo, as specified in the Smart Contract 4108.
e. Activation: Upon purchasing the verified software 4103, consumable print media 4102, and print rights to the logo 4104, the associated crypto tokens may be transferred to the user's digital wallet 4105, activating the software features and granting the user permission to print the copyrighted logo 4106.
f. Consumption Tracking: As the user consumes the print media and prints the logo, the system may update the digital wallet and Smart Contract accordingly, securely tracking the consumption of items and digital rights utilization 4106.
g. Royalty Payments: The Smart Contract may automate royalty payments to the sports team for the use of the copyrighted logo, ensuring transparent and efficient compensation for the logo's usage 4106.

By leveraging DAOs (e.g., verifying consumable print media 4102 and verifying the software 4103) and integrating the entire process of tracking consumables and managing digital rights (e.g., activating software features, granting user permissions, and tracking consumption of items and digital rights utilization 4106), the system disclosed herein may address and/or overcome limitations of current methods, offering a more efficient and reliable solution with broad applications in the global market.

### Consumable Recycling Using Consumable Wallet/Token Labeling

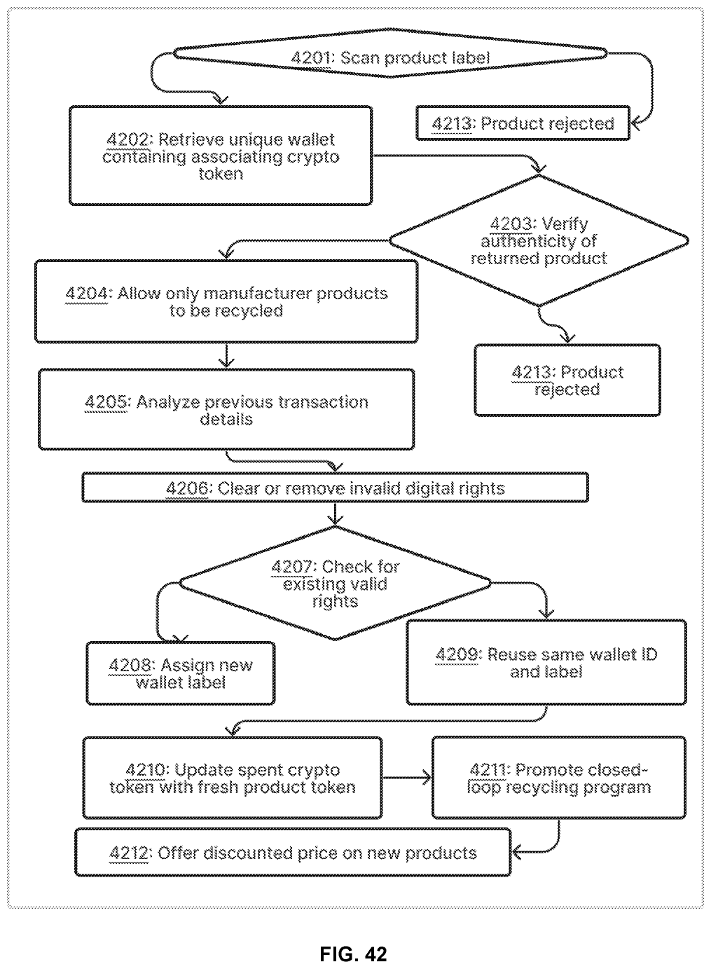

FIG. 42 is a flowchart illustrating an exemplary system for implementing a secure and efficient recycling program for consumable products. By scanning the product label (operation 4201), the unique digital wallet containing the associated crypto token may be retrieved (operation 4202). The system may verify the authenticity of the returned product (operation 4203), ensuring that it is not a counterfeit, which would be rejected (operation 4213), and permit only the manufacturer's authentic products to be recycled (operation 4204), thereby minimizing the risk of counterfeit items entering the supply chain. Before the same digital wallet ID and label may be reused, the previous transaction details may be analyzed (operation 4205) to determine if there are any valid digital rights, and if not, they are cleared or removed (operation 4206) to prevent any potential interference with the reuse of the same digital wallet. If checking the digital wallet for existing valid rights (operation 4207) shows that it holds existing valid rights which cannot be cleared, then a new digital wallet label may assigned to product (operation 4208). Otherwise, the same digital wallet ID and label may be reused (operation 4209). The spent crypto token within the digital wallet may be updated with a fresh product token (operation 4210), thereby promoting a closed-loop recycling program (operation 4211). This approach may contribute to environmental sustainability by reducing waste, and also may incentivize consumers to recycle by facilitating manufacturers to offer a discounted price on a new product through the utilization of marketing technology (operation 4212). The unique digital wallet ID and specific product ID included in the crypto token may provide a guarantee of the reliability and security of the recycling program, benefiting both the manufacturer and the consumer.

### Business Intelligence Using Consumable Token Transaction Monitoring

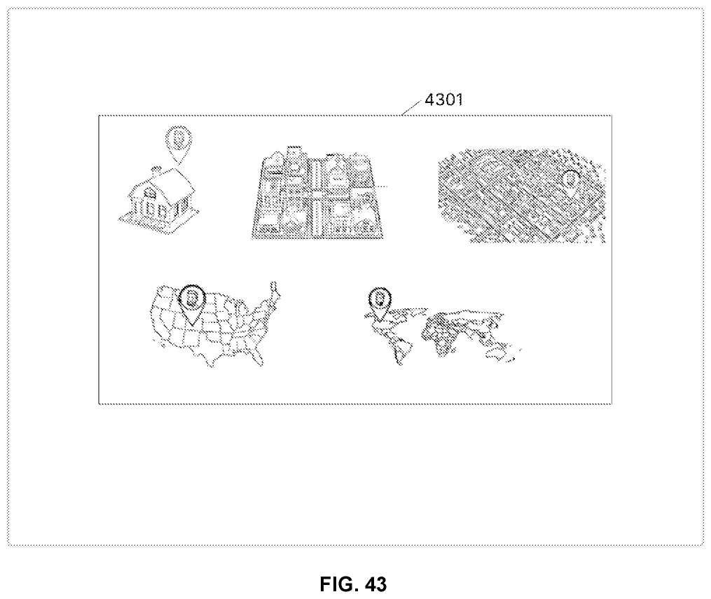

FIG. 43 is an illustration depicting exemplary collection of real-time data on the geographical consumption of products 4301. This may be achieved by accessing the micro-transaction management system or the blockchain, which may provide real-time information on the consumption of the products in different regions. This data may offer valuable insights into market trends, demand forecasting, and the optimization of production and distribution strategies. Additionally, by tracking usage patterns, manufacturers may identify regions where expected usage is lower, indicating potential issues with counterfeit products, and take necessary measures to combat them. The accuracy and reliability of the data may be ensured through the use of blockchain technology and the secure micro-transaction system, providing manufacturers with a trustworthy source of information to make informed business decisions.

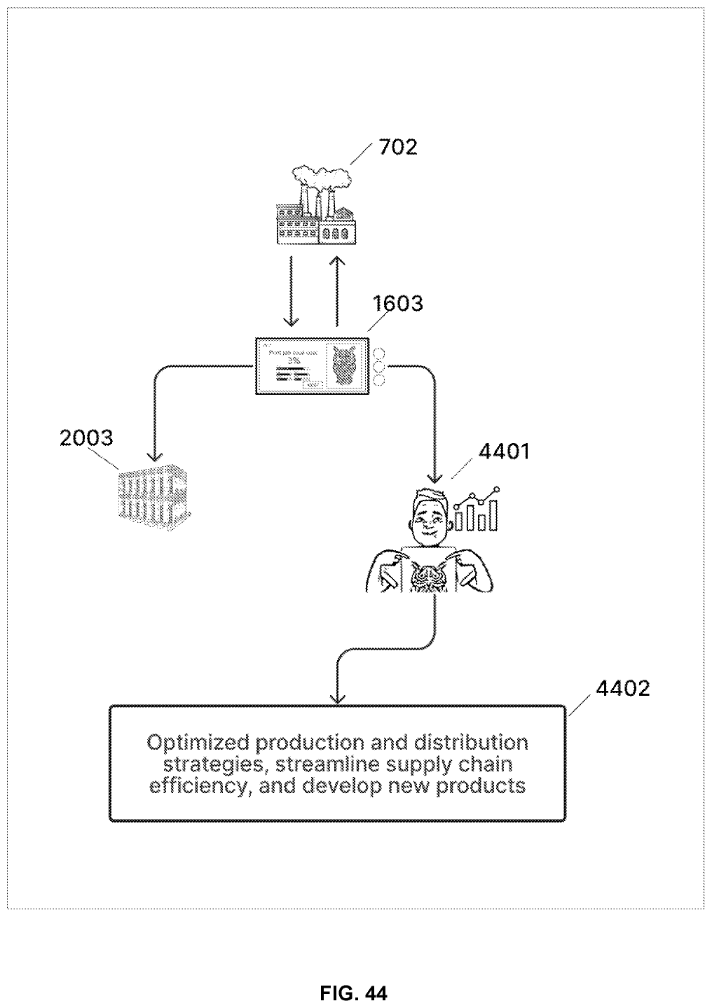

FIG. 44 is a schematic diagram illustrating an exemplary comprehensive solution for manufacturers and their distribution partners 702 to monitor and understand the global consumption 4401 of their products through real-time access to the micro-transaction details 1603. This may facilitate them to gain valuable insights into consumer behavior and patterns 4401, including the popularity of specific products, demand in various regions, and/or the effectiveness of different distribution channels. These insights may be leveraged to optimize production and distribution strategies, streamline supply chain efficiency, and develop new products 4402 that better meet the needs of consumers. Additionally, the system may provide real-time tracking of inventory levels, facilitating manufacturers and distribution partners to quickly identify and address any shortages or overstocking issues, thereby improving their capabilities to ensure products are available to meet consumer demand, reducing the risk of lost sales, and increasing overall revenue. The accuracy and tamper-proof nature of the micro-transaction management system and/or blockchain may provide a reliable source of information for manufacturers 702 to make informed business decisions.

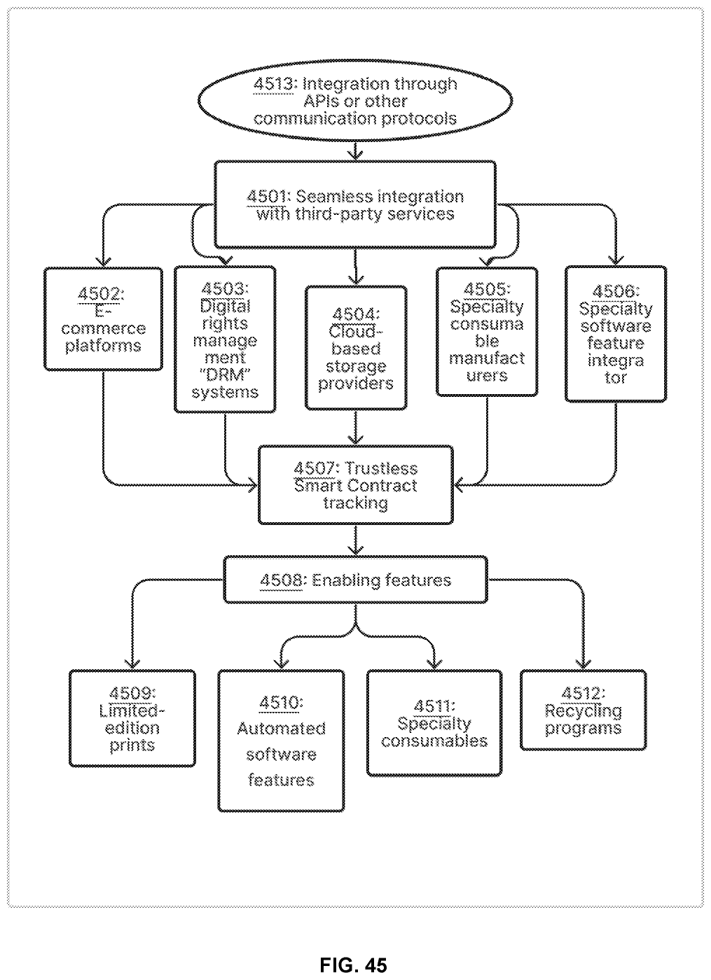

FIG. 45 is a flowchart illustrating an exemplary seamless integration with third-party services 4501, for example, e-commerce platforms 4502, digital rights management (DRM) systems 4503, cloud-based storage providers 4504, specialty consumable manufacturers 4505, specialty software feature integrators 4506, and more. The third-party services 4501 may include or utilize, for example, one or more of the fields of artificial intelligence, machine learning, deep learning, artificial neural networks, deep neural networks, natural language processing, machine vision, data encryption, cybersecurity, etc. This integration may facilitate end-to-end management of the distribution process, streamlining the experience for both providers and consumers. By connecting with these third-party services, exemplary systems as described herein may facilitate trustless Smart Contract tracking 4507 of sales, royalties, and distribution of consumables, and intellectual property. Enabling features 4508, for example, limited-edition prints 4509, automated software features 4510, specialty consumables 4511, and recycling programs 4512. Integration with third-party services may be achieved through APIs or other communication protocols 4513, providing compatibility and interoperability with various platforms and systems.

### Business Expansion Using Customizable Smart Contracts

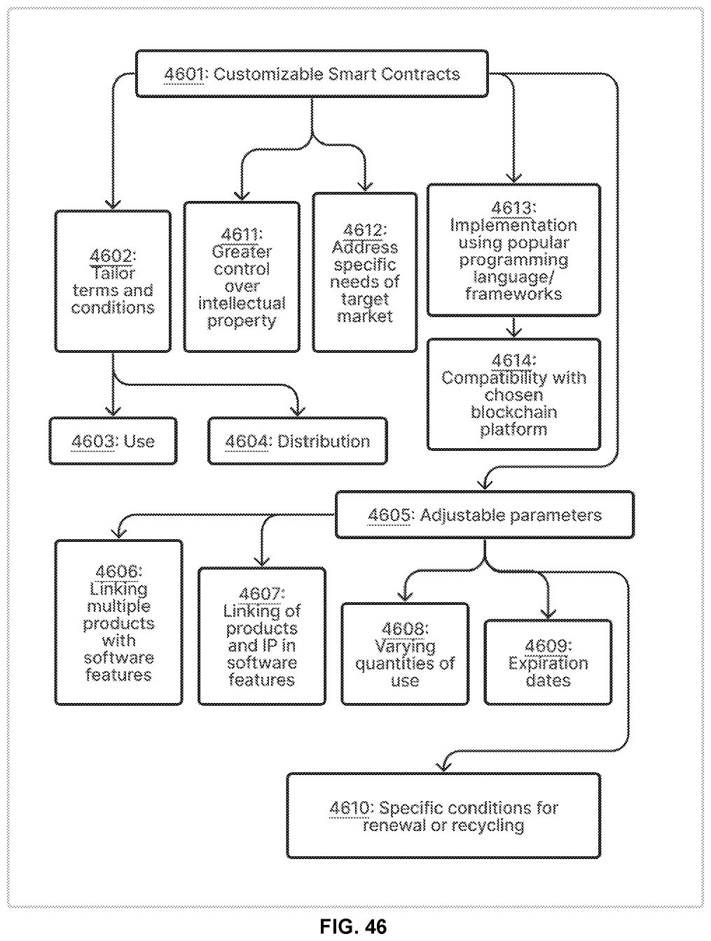

FIG. 46 is a flowchart conceptually illustrating exemplary customizable Smart Contracts and design options to include adjustable parameters for controlling the use, distribution, and recycling of artwork and consumable products. For example, customizable Smart Contracts 4601 may be designed to facilitate creators and manufacturers to tailor the terms and conditions 4602 governing the use 4603 and distribution 4604 of their IP and products. Customizable Smart Contracts may be designed to include adjustable parameters 4605, for example, the linking of multiple products with software features 4606, linking of products and IP in software features 4607, varying quantities of use 4608, expiration dates 4609, and/or specific conditions for renewal or recycling 4610. This added flexibility may facilitate creators and manufacturers to have greater control over their intellectual property 4611 and better address the specific needs of their target market 4612. Customizable Smart Contracts may be implemented using popular programming languages and/or frameworks 4613 that are compatible with the chosen blockchain platform 4614, to provide adaptability and extensibility.

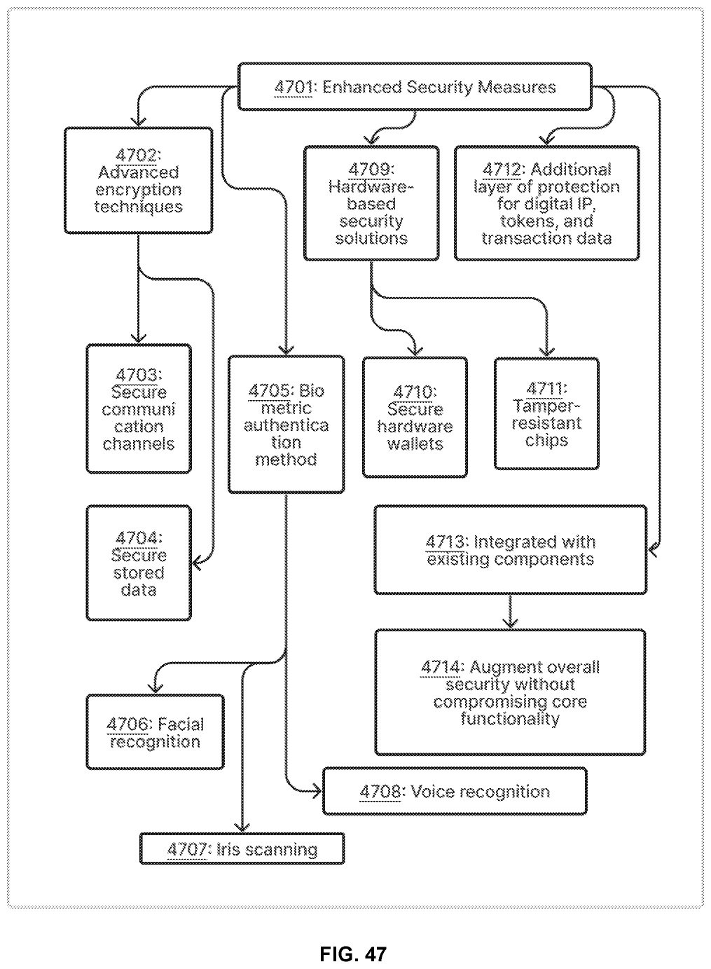

FIG. 47 is a flowchart illustrating exemplary enhanced security measures that may be incorporated into the systems and methods described herein. To further safeguard digital print packages, digital wallets, and transactions, systems and methods described herein may incorporate one or more additional security measures 4701. These measures may include advanced encryption techniques 4702 for securing communication channels 4703 and stored data 4704, biometric authentication methods 4705, for example, facial recognition 4706, iris scanning 4707, and/or voice recognition 4708 for ensuring authorized access, and/or hardware-based security solutions 4709, for example, secure hardware wallets 4710 and/or tamper-resistant chips 4711 for storing sensitive information. The implementation of these enhanced security measures may provide an additional layer of protection for the digital IP, tokens, and transaction data 4712, for providing the system robust security against potential cyber threats or unauthorized access. These measures may be integrated with the existing components 4713 of the system, augmenting the overall security of the system without compromising its core functionality 4714.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A method for controlling access to data and computing systems associated with physical consumable items using crypto tokens, the method comprising:
creating a unique immutable crypto token associated with a physical consumable item;
storing the crypto token on a blockchain computing platform;
linking the crypto token to the physical consumable item by storing data on the crypto token that associates a unique identifier affixed to the physical consumable item with the crypto token;
linking the crypto token with one or more executable functions of a computing system, the linking comprising accessing the crypto token on the blockchain computing platform by the computing system via a decentralized computing network, the one or more executable functions operable to:
authorize consumption of the physical consumable item by accessing, via the decentralized computing network, data stored on the linked crypto token, and processing the accessed data;
responsive to the consumption being authorized, initiate consumption of the physical consumable item,
measure consumption of the physical consumable item, and
store data pertaining to the measured consumption on the linked crypto token via the decentralized computing network;
storing the linked crypto token within a unique digital wallet via a secure computer communications network;
verifying certification of the one or more executable functions with a verification crypto token via the secure computer communications network using a computing system operating system digital signature;
accessing the linked crypto token stored within the unique digital wallet via the secure computer communications network by the computing system;
evaluating, by the computing system, whether the accessed linked crypto token is present and valid using the unique identifier affixed to the physical consumable item to make a determination;
responsive to determining that the accessed linked crypto token is present and valid:
determining a planned amount of consumption of the physical consumable item by execution of the one or more executable functions,
determining an available amount of consumption of the physical consumable item by querying data associated with the physical consumable item on an immutable decentralized data storage network, the available amount of consumption being based at least in part on data pertaining to prior measured consumption of the physical consumable item stored on the immutable decentralized data storage network, and
responsive to the available amount of consumption of the physical consumable item being at least as much as the planned amount of consumption of the physical consumable item, authorizing consumption of the physical consumable item by execution of the one or more executable functions of the computing system;
initiating execution of the one or more executable functions to cause the planned amount of consumption of the physical consumable item;
measuring consumption of the physical consumable item associated with the execution of the one or more executable functions of the computing system;
recording data pertaining to the measured consumption of the physical consumable item on the immutable decentralized data storage network; and
expending the linked crypto token according to the measured consumption of the physical consumable item by the certified one or more executable functions of the computing system.

2. The method of claim 1, wherein the authorizing consumption of the physical consumable item comprises authorizing distribution and printing rights for protected digital artwork, and further comprising:
creating a unique immutable crypto token associated with the physical consumable item for consumption during a printing process of the protected digital artwork, the unique immutable crypto token linked to digital artwork printing rights and stored in a digital wallet;
authorizing printing of the protected digital artwork using the physical consumable item in accordance with the digital artwork printing rights represented by the unique immutable crypto token based on the unique immutable crypto token using a linked executable function within the computing system;
responsive to authorizing the printing of the protected digital artwork, linking expenditure of printing rights with the expenditure of the linked crypto token associated with the physical consumable item, wherein each print job for the authorized prints using the physical consumable item reduces a crypto token balance corresponding to the authorized prints and a crypto token balance corresponding to the consumed physical consumable item;
generating a digital print package that includes a watermarked preview image of the digital artwork, the unique immutable crypto token representing a quantity of authorized prints and the associated physical consumable item, and a valid digital wallet account for managing the unique immutable crypto token; and
distributing the digital print package through a standalone Smart Contract adapted for secure and verifiable transactions for digital artwork printing rights and the associated physical consumable item.

3. (canceled)

4. The method of claim 2, further comprising:
monitoring the consumption of the physical consumable item during a printing process of the protected digital artwork;
comparing the monitored consumption with an authorized amount of consumption based on the crypto token associated with the digital artwork printing rights; and
disallowing further prints of the protected digital artwork to be generated after the monitored consumption equals and/or exceeds the authorized amount of consumption based on the crypto token associated with the digital artwork printing rights.

5. (canceled)

6. The method of claim 1, further comprising:
receiving the physical consumable item to be recycled;
verifying authenticity of the physical consumable item to be recycled based on the unique digital wallet containing the linked crypto token associated with the physical consumable item to be recycled; and
responsive to verifying the authenticity of the physical consumable item, updating a spent amount of the verified physical consumable item expenditures in the associated linked crypto token within the unique digital wallet associated with the verified physical consumable item to be recycled, the spent amount being updated to an amount permitting further expenditures of the verified physical consumable item.

7. The method of claim 6, wherein the updating the spent amount of the verified physical consumable item expenditures in the associated linked crypto token within the unique digital wallet associated with the verified physical consumable item to be recycled comprises:
evaluating whether the unique digital wallet of the verified physical consumable item being recycled is holding valid existing digital rights to make a determination;
responsive to determining that the unique digital wallet of the verified physical consumable item being recycled is holding valid existing digital rights, assigning a new digital wallet to the verified physical consumable item being recycled; and
responsive to determining that the unique digital wallet of the verified physical consumable item being recycled is not holding valid existing digital rights, clearing and/or removing previous micro-transaction details from the unique digital wallet of the verified physical consumable item, and updating the spent crypto token within the unique digital wallet of the verified physical consumable item being recycled with a fresh crypto token for the verified physical consumable item.

8. A non-transitory computer-readable medium having stored thereon computer-readable instructions executable by a hardware computing processor to perform operations of a method for controlling access to data and computing systems associated with physical consumable items using crypto tokens, the method comprising:
creating a unique immutable crypto token associated with a physical consumable item;
storing the crypto token on a blockchain computing platform;
linking the crypto token to the physical consumable item by storing data on the crypto token that associates a unique identifier affixed to the physical consumable item with the crypto token;
linking the crypto token with one or more executable functions of a computing system, the linking comprising accessing the crypto token on the blockchain computing platform by the computing system via a decentralized computing network, the one or more executable functions operable to:
authorize consumption of the physical consumable item by accessing, via the decentralized computing network, data stored on the linked crypto token, and processing the accessed data;
responsive to the consumption being authorized, initiate consumption of the physical consumable item,
measure consumption of the physical consumable item, and
store data pertaining to the measured consumption on the linked crypto token via the decentralized computing network;
storing the linked crypto token within a unique digital wallet via a secure computer communications network;
verifying certification of the one or more executable functions with a verification crypto token via the secure computer communications network using a computing system operating system digital signature;
accessing the linked crypto token stored within the unique digital wallet via the secure computer communications network by the computing system;
evaluating, by the computing system, whether the accessed linked crypto token is present and valid using the unique identifier affixed to the physical consumable item to make a determination;
responsive to determining that the accessed linked crypto token is present and valid:
determining a planned amount of consumption of the physical consumable item by execution of the one or more executable functions,
determining an available amount of consumption of the physical consumable item by querying data associated with the physical consumable item on an immutable decentralized data storage network, the available amount of consumption being based at least in part on data pertaining to prior measured consumption of the physical consumable item stored on the immutable decentralized data storage network, and
responsive to the available amount of consumption of the physical consumable item being at least as much as the planned amount of consumption of the physical consumable item, authorizing consumption of the physical consumable item by execution of the one or more executable functions of the computing system;
initiating execution of the one or more executable functions to cause the planned amount of consumption of the physical consumable item;
measuring consumption of the physical consumable item associated with the execution of the one or more executable functions of the computing system;
recording data pertaining to the measured consumption of the physical consumable item on the immutable decentralized data storage network; and
expending the linked crypto token according to the measured consumption of the physical consumable item by the certified one or more executable functions of the computing system.

9. The non-transitory computer-readable medium of claim 8, wherein the authorizing consumption of the physical consumable item comprises authorizing distribution and printing rights for protected digital artwork, and further comprising computer-readable instructions for performing operations of:
creating a unique immutable crypto token associated with the physical consumable item for consumption during a printing process of the protected digital artwork, the unique immutable crypto token linked to digital artwork printing rights and stored in a digital wallet;
authorizing printing of the protected digital artwork using the physical consumable item in accordance with the digital artwork printing rights represented by the unique immutable crypto token based on the unique immutable crypto token using a linked executable function within the computing system;
responsive to authorizing the printing of the protected digital artwork, linking expenditure of printing rights with the expenditure of the linked crypto token associated with the physical consumable item, wherein each print job for the authorized prints using the physical consumable item reduces a crypto token balance corresponding to the authorized prints and a crypto token balance corresponding to the consumed physical consumable item;
generating a digital print package that includes a watermarked preview image of the digital artwork, the unique immutable crypto token representing a quantity of authorized prints and the associated physical consumable item, and a valid digital wallet account for managing the unique immutable crypto token; and
distributing the digital print package through a standalone Smart Contract adapted for secure and verifiable transactions for digital artwork printing rights and the associated physical consumable item.

10. (canceled)

11. The non-transitory computer-readable medium of claim 9, further comprising computer-readable instructions for performing operations of:
monitoring the consumption of the physical consumable item during a printing process of the protected digital artwork;
comparing the monitored consumption with an authorized amount of consumption based on the crypto token associated with the digital artwork printing rights; and
disallowing further prints of the protected digital artwork to be generated after the monitored consumption equals and/or exceeds the authorized amount of consumption based on the crypto token associated with the digital artwork printing rights.

12. (canceled)

13. The non-transitory computer-readable medium of claim 8, further comprising computer-readable instructions for performing operations of:
receiving the physical consumable item to be recycled;
verifying authenticity of the physical consumable item to be recycled based on the unique digital wallet containing the linked crypto token associated with the physical consumable item to be recycled; and
responsive to verifying the authenticity of the physical consumable item, updating a spent amount of the verified physical consumable item expenditures in the associated linked crypto token within the unique digital wallet associated with the verified physical consumable item to be recycled, the spent amount being updated to an amount permitting further expenditures of the verified physical consumable item.

14. The non-transitory computer-readable medium of claim 13, wherein the updating the spent amount of the verified physical consumable item expenditures in the associated linked crypto token within the unique digital wallet associated with the verified physical consumable item to be recycled comprises:
evaluating whether the unique digital wallet of the verified physical consumable item being recycled is holding valid existing digital rights to make a determination;
responsive to determining that the unique digital wallet of the verified physical consumable item being recycled is holding valid existing digital rights, assigning a new digital wallet to the verified physical consumable item being recycled; and
responsive to determining that the unique digital wallet of the verified physical consumable item being recycled is not holding valid existing digital rights, clearing and/or removing previous micro-transaction details from the unique digital wallet of the verified physical consumable item, and updating the spent crypto token within the unique digital wallet of the verified physical consumable item being recycled with a fresh crypto token for the verified physical consumable item.

15. A system for controlling access to data and computing systems associated with physical consumable items using crypto tokens, the system comprising:
a hardware computing processor configured to execute computing instructions; and
a non-transitory memory device having stored thereon computer-readable instructions executable by the hardware computing processor to perform operations of a method for controlling access to data and computing systems associated with physical consumable items using crypto tokens, the method comprising:
creating a unique immutable crypto token associated with a physical consumable item;
storing the crypto token on a blockchain computing platform;
linking the crypto token to the physical consumable item by storing data on the crypto token that associates a unique identifier affixed to the physical consumable item with the crypto token;
linking the crypto token with one or more executable functions of a computing system, the linking comprising accessing the crypto token on the blockchain computing platform by the computing system via a decentralized computing network, the one or more executable functions operable to:
authorize consumption of the physical consumable item by accessing, via the decentralized computing network, data stored on the linked crypto token, and processing the accessed data;
responsive to the consumption being authorized, initiate consumption of the physical consumable item,
measure consumption of the physical consumable item, and
store data pertaining to the measured consumption on the linked crypto token via the decentralized computing network;
storing the linked crypto token within a unique digital wallet via a secure computer communications network;
verifying certification of the one or more executable functions with a verification crypto token via the secure computer communications network using a computing system operating system digital signature;
accessing the linked crypto token stored within the unique digital wallet via the secure computer communications network by the computing system;
evaluating, by the computing system, whether the accessed linked crypto token is present and valid using the unique identifier affixed to the physical consumable item to make a determination;
responsive to determining that the accessed linked crypto token is present and valid:
determining a planned amount of consumption of the physical consumable item by execution of the one or more executable functions,
determining an available amount of consumption of the physical consumable item by querying data associated with the physical consumable item on an immutable decentralized data storage network, the available amount of consumption being based at least in part on data pertaining to prior measured consumption of the physical consumable item stored on the immutable decentralized data storage network, and
responsive to the available amount of consumption of the physical consumable item being at least as much as the planned amount of consumption of the physical consumable item, authorizing consumption of the physical consumable item by execution of the one or more executable functions of the computing system;
initiating execution of the one or more executable functions to cause the planned amount of consumption of the physical consumable item;
measuring consumption of the physical consumable item associated with the execution of the one or more executable functions of the computing system;
recording data pertaining to the measured consumption of the physical consumable item on the immutable decentralized data storage network; and
expending the linked crypto token according to the measured consumption of the physical consumable item by the certified one or more executable functions of the computing system.

16. The system of claim 15, wherein the authorizing consumption of the physical consumable item comprises authorizing distribution and printing rights for protected digital artwork, and the non-transitory memory device further comprising computer-readable instructions for performing operations of:
creating a unique immutable crypto token associated with the physical consumable item for consumption during a printing process of the protected digital artwork, the unique immutable crypto token linked to digital artwork printing rights and stored in a digital wallet;
authorizing printing of the protected digital artwork using the physical consumable item in accordance with the digital artwork printing rights represented by the unique immutable crypto token based on the unique immutable crypto token using a linked executable function within the computing system;
responsive to authorizing the printing of the protected digital artwork, linking expenditure of printing rights with expenditure of the linked crypto token associated with the physical consumable item, wherein each print job for the authorized prints using the physical consumable item reduces a crypto token balance corresponding to the authorized prints and a crypto token balance corresponding to the consumed physical consumable item;
generating a digital print package that includes a watermarked preview image of the digital artwork, the unique immutable crypto token representing a quantity of authorized prints and the associated physical consumable item, and a valid digital wallet account for managing the unique immutable crypto token; and
distributing the digital print package through a standalone Smart Contract adapted for secure and verifiable transactions for digital artwork printing rights and the associated physical consumable item.

17. (canceled)

18. The system of claim 16, the non-transitory memory device further comprising computer-readable instructions for performing operations of:
monitoring the consumption of the physical consumable item during a printing process of the protected digital artwork;
comparing the monitored consumption with an authorized amount of consumption based on the crypto token associated with the digital artwork printing rights; and
disallowing further prints of the protected digital artwork to be generated after the monitored consumption equals and/or exceeds the authorized amount of consumption based on the crypto token associated with the digital artwork printing rights.

19. The system of claim 15, the non-transitory memory device further comprising computer-readable instructions for performing operations of:
receiving the physical consumable item to be recycled;
verifying authenticity of the physical consumable item to be recycled based on the unique digital wallet containing the linked crypto token associated with the physical consumable item to be recycled; and
responsive to verifying the authenticity of the physical consumable item, updating a spent amount of the verified physical consumable item expenditures in the associated linked crypto token within the unique digital wallet associated with the verified physical consumable item to be recycled, the spent amount being updated to an amount permitting further expenditures of the verified physical consumable item.

20. The system of claim 19, wherein the updating the spent amount of the verified physical consumable item expenditures in the associated linked crypto token within the unique digital wallet associated with the verified physical consumable item to be recycled comprises:
evaluating whether the unique digital wallet of the verified physical consumable item being recycled is holding valid existing digital rights to make a determination;
responsive to determining that the unique digital wallet of the verified physical consumable item being recycled is holding valid existing digital rights, assigning a new digital wallet to the verified physical consumable item being recycled; and
responsive to determining that the unique digital wallet of the verified physical consumable item being recycled is not holding valid existing digital rights, clearing and/or removing previous micro-transaction details from the unique digital wallet of the verified physical consumable item, and updating the spent crypto token within the unique digital wallet of the verified physical consumable item being recycled with a fresh crypto token for the verified physical consumable item.

21. The method of claim 1, wherein:
recording the measured consumption includes recording the measured consumption as transactions on the immutable decentralized data storage network; and
expending the linked crypto token includes comparing a sum of the transactions on the immutable decentralized data storage network to a total sum associated with the physical consumable item as recorded in the linked crypto token.

22. The method of claim 1, wherein:
execution of the one or more executable functions comprises performing a printing process; and
the physical consumable item includes a printable substrate on which printing is performed during the printing process.

23. The non-transitory computer-readable medium of claim 8, wherein:
recording the measured consumption includes recording the measured consumption as transactions on a blockchain; and
expending the linked crypto token includes comparing a sum of the transactions on the blockchain to a total sum associated with the physical consumable item as recorded in the linked crypto token.

24. The non-transitory computer-readable medium of claim 8, wherein:
execution of the one or more executable functions comprises performing a printing process; and
the physical consumable item includes consumable ink and/or toner with which printing is performed during the printing process.

25. The system of claim 15, wherein:
recording the measured consumption includes recording the measured consumption as transactions on the immutable decentralized data storage network; and
expending the linked crypto token includes comparing a sum of the transactions on the immutable decentralized data storage network to a total sum associated with the physical consumable item as recorded in the linked crypto token.
